(19) United States
(12) Patent Application Publication
(10) Pub. No.: US 2012/0270576 A1
(43) Pub. Date: Oct. 25, 2012

(54) SYSTEM AND METHOD FOR PARTNERED MEDIA STREAMING

(75) Inventors: Daniel Joseph Herrington, Brandon, MS (US); Mark D. Roberts, Huntsville, AL (US)

(73) Assignee: Intuitive Research and Technology Corporation, Huntsville, AL (US)

(21) Appl. No.: 13/092,513

(22) Filed: Apr. 22, 2011

(51) Int. Cl. H04W 4/06

(52) U.S. Cl. 455/466

(57) ABSTRACT

A system and method for delivering a content stream, for example, deadline driven (live) content stream or non-deadline driven (pre-stored) content stream, from a content source to a content player associates a plurality of smartphones with a partnered smartphone group that share their resources for delivering the content stream transmitted from the content source based on a partnership profile stored in a partnership profile storage device. A content segmentation process is executed at a segmentation processing node that converts the content stream into a plurality of content segments according to a segmentation rule. The plurality of content segments are transmitted to the partnered smart phone group over a first plurality of communication links and the plurality of content segments from the smartphone group are transmitted towards the content player over a second plurality of communication links. The transmission over the second plurality of communication links is based on information stored in the partnership profile that specify at least one condition information for at least one of the plurality of smartphones to share its resource with resources of one or more other smartphones of the plurality of smartphones.

### FIELD OF THE INVENTION

The present invention relates generally to a system and method for media streaming. More particularly, the present invention relates to a system and method for media streaming using partnered smartphone devices to create a combined media stream output greater than a media stream output that any one of the partnered smartphone devices is capable of creating by itself.

### BACKGROUND OF THE INVENTION

There are several well-known systems and methods for media streaming. FIG. 1A depicts a first prior art media streaming approach 100 involving a communications link between a satellite 108 and a satellite dish antenna 106, where a media player (e.g., a television) 102 receives a content 116 (e.g., a movie) provided via a satellite 108, where the media player 102 is connected to a satellite box (or set top box) 104 that is connected to a satellite dish antenna 106 that is receiving the content 116 from a satellite 108 in Earth orbit. The media player 102 is connected to the satellite box 104 via a first communications link 110, which would typically be a wired link but which could be a wireless link. The satellite box 104 is connected to the satellite dish antenna using a second communications link 112, which would also typically be a wired link but which could be a wireless link. The satellite dish antenna receives the content 116 from the satellite 108 via a third communications link 114, which is a wireless link. As such, the media player is able to play content 116 such as television shows, movies, and the like provided by a service (e.g., a satellite TV service) via the satellite 108, where the content 116 is provided via a single data stream 118.

FIG. 1B depicts a second prior art approach 120 to data streaming that involves a communication link 126 between a smartphone 122 and a cellular site 124 (e.g., a cellular tower), where the smartphone 122 is itself a media player that can send and receive content 116 (e.g., music or video) to and from the cellular site 124 via a first communications link that is a wireless (cellular) link. The cellular site 124 is connected via a cellular network to another device such as another smartphone, the Internet, and the like, where the content 116 is sent and received between the smartphone 122 and the other device via a single data stream 118. With this approach, the bandwidth capabilities and limitations of the smartphone 122 determine the maximum amount of information that can be transferred over the first communications link, where the capabilities and limitations of the cellular site 124 are understood to be substantially greater than that of the smartphone 122.

FIG. 1C depicts a third prior art approach 130 to data streaming where multiplexer/demultiplexer (MUX/DEMUX) devices 132a 132b utilize multiple communications links 134a-134n to achieve higher bandwidth between two devices such as two media players 102a 102b than could otherwise be achieved using only one communications link 134 of the multiple communications links 134a-134n. With this approach, the higher bandwidth enables content 116 that is much larger, since the content 116 can be multiplexed (i.e., disassembled into multiple content portions), conveyed across the multiple communications links 134a-134n as multiple data streams 118a-118n, and then demultiplexed (i.e., reassembled into the content 116). Generally, the person(s) configuring the MUX/DEMUX devices 132a 132b will select among available communications links 134a-134n, which could include land lines, cellular links, and other types of communication links, where the person(s) have access rights to each of the communications links employed. As such, considerable coordination among available resources is required to configure the MUX/DEMUX devices 132a 132b to employ the communications links 134a-134n. A MUX/DEMUX device can also be referred to as a segmentation/recombination processing node.

With advances in communication technologies, it is desirable to have an improved system and method for media streaming using smartphones.

### SUMMARY OF THE INVENTION

Briefly according to the present invention, a system and method for delivering a content stream, for example, a deadline driven (live) content stream or non-deadline driven (pre-stored) content stream, from a content source to a content player associates a plurality of smartphones with a partnered smartphone group that share their resources for delivering the content stream transmitted from the content source based on a partnership profile stored in a partnership profile storage device. A content segmentation process is executed at a segmentation processing node that converts the content stream into a plurality of content segments according to a segmentation rule. The plurality of content segments are transmitted to the partnered smart phone group over a first plurality of communication links and the plurality of content segments are transmitted from the partnered smartphone group towards the content player over a second plurality of communication links. The transmissions over the first and second plurality of communication links is based on information stored in the partnership profile that specify at least one condition information for at least one of the plurality of smartphones to share its resources with resources of one or more other smartphones of the plurality of smartphones.

According to some of the more detailed features of the present invention, a recombining process is executed that recombines the plurality of content segments to generate a recombined content stream and applies the recombined content stream to the content player. In one embodiment, the segmentation process comprises a multiplexing process and the recombining process comprises a demultiplexing process. The shared resources according to the present invention comprise any one of communication resources, computing resources and storage resources. The condition information could relate to position information associated with the plurality of smartphones relative to each other. Alternatively, the condition information could relate to a smartphone attribute or a communication link attribute, such as received signal strength determined at one of the smartphones.

According to other more detailed features of the present invention, the first plurality of communication links could be wired or wireless links and the second plurality of communication links could be wired or wireless communication links. In one embodiment, the first plurality of communication links comprises communication links of a cellular network. The partnership profile storage device could comprise a database accessible by a server associated with the content source or a storage device accessible by a processing unit within a smartphone. The plurality of smartphones could communicate with each other over an ad-hoc network.

According to still other more detailed features of the present invention, the segmentation processing node could be located at the content source, which itself may be a stand-alone computer, or it could be located in a smartphone. The recombining processing node could be located at the content player. Further, a smartphone could be removed from the partnered smartphone group when the smartphone is determined to be unavailable or it could be added when the smartphone is determined to be available.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A depicts a first prior art media streaming approach that involves a communications link between a satellite and a satellite dish antenna;

FIG. 1B depicts a second prior art media streaming approach that involves a communication link between a smartphone and a cellular site;

FIG. 1C depicts a third prior art approach to data streaming where two multiplexer/demultiplexer devices utilize multiple communications links to achieve higher bandwidth between two devices than could be gotten using one of the multiple communications links;

FIG. 2A depicts an exemplary streaming system involving a partnered smartphone group and a partnered media control box used to provide high bandwidth data streaming between a media player and a cellular site(s) in accordance with the present invention;

FIG. 2B depicts another exemplary streaming system involving a partnered smartphone group and a partnered media control box used to provide high bandwidth data streaming between a media player and a cellular site(s) in accordance with the present invention;

FIG. 2C depicts yet another exemplary streaming system involving a partnered smartphone group used to provide high bandwidth data streaming between a media player having partnered media control capability and a cellular site(s) in accordance with the present invention;

FIG. 2D depicts still another exemplary streaming system involving a partnered smartphone group used to provide high bandwidth data streaming between a media player having partnered media control capability and a cellular site(s) in accordance with the present invention;

FIG. 3A depicts an exemplary network enabling content to be delivered to media players via cellular wireless communications links and partnered smartphone groups in accordance with the present invention;

FIG. 3B depicts another exemplary network enabling content to be delivered to media players via cellular wireless communications links and partnered smartphone groups in accordance with the present invention;

FIG. 4A depicts an exemplary streaming system involving a partnered smartphone group and a partnered media control box used to provide high bandwidth data streaming between a media player and a computer in accordance with the present invention;

FIG. 4B depicts another exemplary streaming system involving a partnered smartphone group and a partnered media control box used to provide high bandwidth data streaming between a media player and a computer in accordance with the present invention;

FIG. 4C depicts yet another exemplary streaming system involving a partnered smartphone group and used to provide high bandwidth data streaming between a media player having partnered media control capability and a computer in accordance with the present invention;

FIG. 4D depicts still another exemplary streaming system involving a partnered smartphone group used to provide high bandwidth data streaming between a media player having partnered media control capability and a computer in accordance with the present invention;

FIG. 5A depicts an exemplary network enabling content to be delivered to media players via wireless communications links between a computer(s) and partnered smartphone groups in accordance with the present invention;

FIG. 5B depicts another exemplary network enabling content to be delivered to media players via wireless communications links between a computer(s) and partnered smartphone groups in accordance with the present invention;

FIG. 6A depicts an exemplary streaming system involving multiple partnered smartphone groups used to provide high bandwidth data streaming between multiple media players in accordance with the present invention;

FIG. 6B depicts an alternative exemplary streaming system involving multiple partnered smartphone groups used to provide high bandwidth data streaming between multiple media players in accordance with the present invention;

FIG. 6C depicts another exemplary streaming system involving multiple partnered smartphone groups used to provide high bandwidth data streaming between multiple media players in accordance with the present invention;

FIG. 6D depicts yet another exemplary streaming system involving multiple partnered smartphone groups used to provide high bandwidth data streaming between multiple media players in accordance with the present invention;

FIG. 6E depicts still another exemplary streaming system involving multiple partnered smartphone groups used to provide high bandwidth data streaming between multiple media players in accordance with the present invention;

FIG. 6F depicts an exemplary streaming system involving multiple partnered smartphone groups used to provide high bandwidth data streaming between multiple media players having partnered media control capability in accordance with the present invention;

FIG. 6G depicts an alternative exemplary streaming system involving multiple partnered smartphone groups used to provide high bandwidth data streaming between multiple media players having partnered media control capability in accordance with the present invention;

FIG. 6H depicts another exemplary streaming system involving multiple partnered smartphone groups used to provide high bandwidth data streaming between multiple media players having partnered media control capability in accordance with the present invention;

FIG. 6I depicts yet another exemplary streaming system involving multiple partnered smartphone groups used to provide high bandwidth data streaming between multiple media players having partnered media control capability in accordance with the present invention;

FIG. 6J depicts still another exemplary streaming system involving multiple partnered smartphone groups used to provide high bandwidth data streaming between multiple media players having partnered media control capability in accordance with the present invention;

FIG. 7A depicts a first exemplary method for streaming between a first media player and first control box to a second media player and second control box in accordance with the present invention;

FIG. 7B depicts a second exemplary method for streaming between a content source and a media player in accordance with the present invention;

FIG. 8A depicts a first exemplary method for streaming between a first computing device and first control box to a second computing device and second control box in accordance with the present invention;

FIG. 8B depicts a second exemplary method for streaming between a first computing device and first control box to a second computing device and second control box in accordance with the present invention;

FIG. 9A depicts a first exemplary method for streaming between a first computing device and a second computing device in accordance with the present invention;

FIG. 9B depicts a second exemplary method for streaming between a first computing device and a second computing device in accordance with the present invention;

FIG. 10 depicts an exemplary method for establishing a data stream attribute based on a determined smartphone attribute;

FIG. 11 depicts an exemplary method for adding a smartphone to a partnered smartphone group when a smartphone is determined to be available;

FIG. 12 depicts an exemplary method for removing a smartphone from a partnered smartphone group when a smartphone is determined to be unavailable;

FIG. 13 depicts an exemplary method for establishing a data stream attribute based on a determined communications link attribute;

FIG. 14 depicts an exemplary method for controlling access to a partnered smartphone group based on defined access controls for smartphone users;

FIG. 15 depicts an exemplary method for rewarding an owner of a smartphone for determined usage of the smartphone in a partnered smartphone group;

FIG. 16A depicts an exemplary method 1600 of multiplexing content into multiple content portions for conveyance as multiple data streams by at least one partnered smartphone group; and

FIG. 16B depicts an exemplary method of formatting multiple data streams.

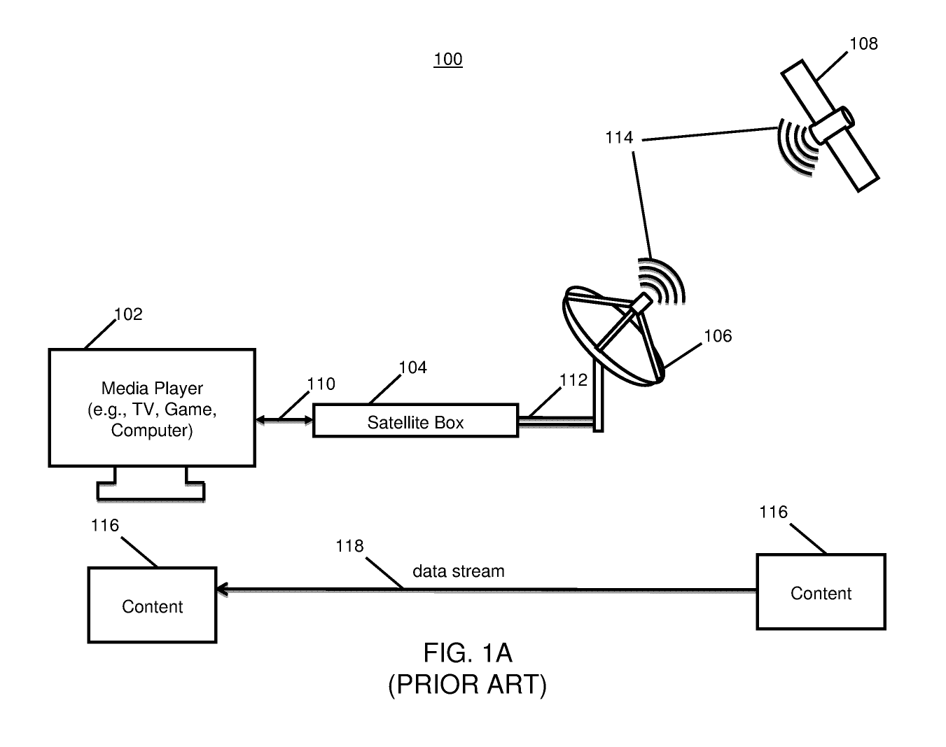

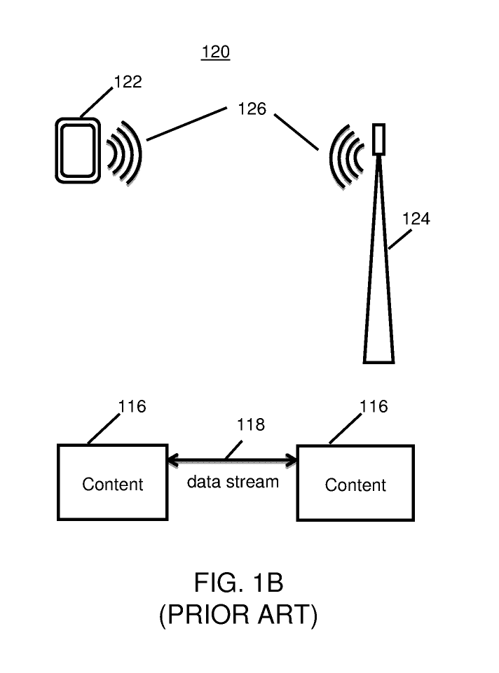

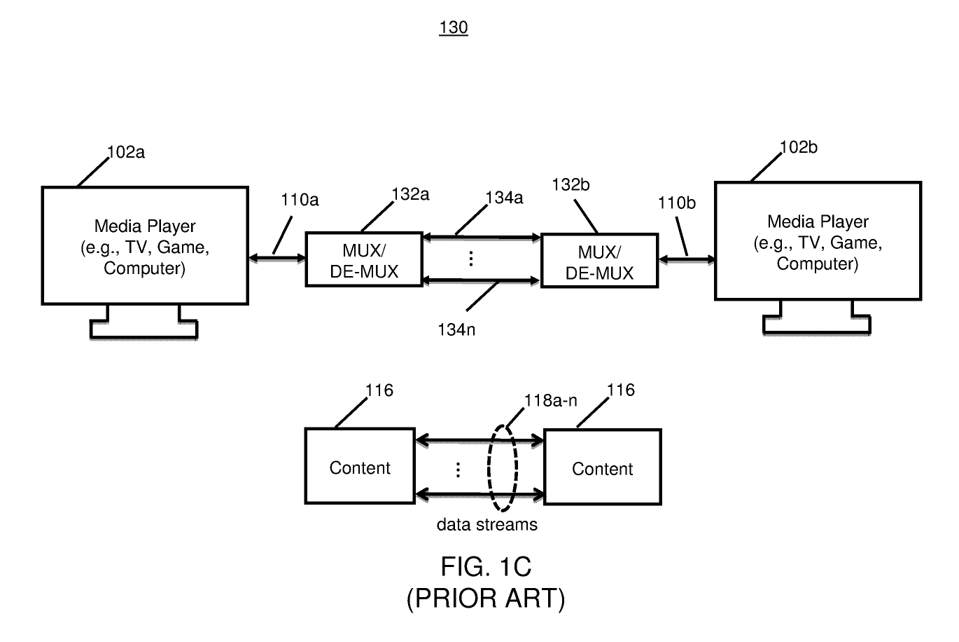

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

The present invention delivers a content stream from one or more content sources to one or more content players. A plurality of smartphones is associated with a partnered smartphone group that share their resources for delivering the content stream transmitted from the content source to the content player. The resource sharing is based on a partnership profile stored in a partnership profile storage device, e.g., a database or flash memory. A segmentation processing node executes a content segmentation process that converts the content stream into a plurality of content segments, which are transmitted to the partnered smart phone group over a first plurality of communication links. The plurality of content segments from the smartphone group is transmitted towards the content player over a second plurality of communication links. The transmission over the second plurality of communication links is based on information stored in the partnership profile. The information specifies one or more condition information for sharing resources amongst the plurality of smartphones. In this way, the present invention delivers content streams transmitted from one or more content sources to one or more content players by associating a plurality of smartphones with one or more partnered smartphone groups, where each smartphone delivers one or more segments of a streaming content received from a content source to a content player that plays a recombined version of the transmitted content stream.

Smartphones as used herein corresponds to a mobile device with computing, processing, communication and storage resources, among others, that runs under a mobile device operating system, such as Google's Android, Apple iOS, Blackberry OS or Windows, providing a platform for application developers. A smartphone could be a handheld computer or tablet integrated with a mobile telephone capable of running applications based on platforms such as Java ME. Some examples of smartphones that could be used with the present invention are mobile devices manufactured by Motorola, Apple and Research-In-Motion (RIM). A content segment as used here comprises a portion of the transmitted content but not all of it. Content segmentation can comprise various processes included multiplexing, sub-division or disassembly of the transmitted content stream according to a segmentation process or algorithm. Content recombination on the other hand involves the reverse process to segmentation, including demultiplexing or reassembly of the segmented content to regenerate a version of the content that when played at a content player corresponds to a content transmitted from the content source.

The plurality of smartphones is partnered in a group according to a partnership profile that is stored in a database or other suitable storage device accessible by a computing device or processing node of a network. The information stored in the partnership profile specifies the conditions (e.g., when and how) any one of the plurality of smartphones uses its own resources in partnership with resources of one or more other smartphones of the plurality of smartphones for delivering segments of the originated content stream to the content player in a collective manner. Thus, a partnered smartphone group comprises the plurality of smartphones each configured to partner with at least one other smartphone of the plurality of smartphones. The content segments for each one of the plurality of smartphones is generated by a content segmentation process that converts the transmitted content stream into a plurality of content segments according to a segmentation or ordering rule for delivery to the plurality of smartphones according to the conditions and/or resources specified in the partnership profile.

A plurality of communication links are established between each one of the plurality of smartphones of the partnered smartphone group and the content source for delivering content segments to each one of the plurality of smartphones of the partnered smartphone group that participates in the content delivery process based on information stored in the partnership profile. Such stored information could specify which or how much of the resources of a smartphone should be assigned to delivery of a content segment(s) to the content player. In this way, the present invention uses the resources of the plurality of smartphones in combination to deliver a sequence of the plurality of content segments to a reassembly processor that converts the content segment sequence into a reassembled content that corresponds to content as it originated at the content source. Implementation of the present invention requires processing or computing nodes that access storage devices. The nodes could be wired or wireless network nodes as well as stand alone computing devices with processing units that could execute application software and algorithms that rely on partnership profile information. Partnership profile information could be stored in any type of storage device including a storage profile database that is accessible by a server or a hard drive of a computing device that is accessible by a CPU or flash memory that is accessible by the processing unit of a smartphone.

Accordingly, the present invention provides an improved media streaming system and method where multiple smartphone owners establish or create a partnership such that their smartphones function together as a partnered smartphone group. A partnered smartphone group comprises a group (i.e., a plurality of) smartphones that are configurable to combine or otherwise share all or part of their processing, storage and/or communications resources, hardware or software, with each other to participate in the delivery of a content stream originating at a content source. As herein used, the term content stream comprises deadline driven, e.g., virtually live, content streams or non-deadline driven, e.g., pre-stored, content streams, such as video, game, music, audio, text, etc. According to the present invention, a transmitted content stream is processed to generate a sequence of content segments that comprise sub-components of the transmitted content stream.

The content processing according to the present invention comprises a transmitted content segmentation, disassembly or division process and a received content sequence reassembly or recombination process that allows one or more partnered smartphone groups to efficiently deliver content to a content player via the combination of available resources of the smartphones in a partnered group. During, the transmitted content segmentation or disassembly process, a transmitted content stream is converted into a plurality of content segments that are sequenced or ordered according to a segmentation, ordering or sequencing rule that may involve identifying and or positioning each content segment within a content segment sequence. The ordering of the content segments by the segmentation or disassembly process could be based on any suitable ordering algorithm that for example, identifies or positions each content segment within the content sequence according to a hardware or software implemented segment ordering rule. The content segments of the content stream are conveyed from the content source to the content player using the partnered smartphone group's resources such as bandwidth, processing/computing power, memory/storage as well software used for virtual processing, virtual storage and virtual network. During the content reassembly process, a received content segment sequence is processed according to the segment ordering rule to regenerate the transmitted content stream.

Generally, the smartphones of a partnered smartphone group combine communications bandwidth (and optionally other resources) to achieve greater bandwidth between a content provider and a media player (e.g., a computer, game or television) than the bandwidth any one of the smartphones in the partnered smartphone group could achieve alone. The process of combining smartphone resources within each partnered group could involve executing one or more resource management applications either in a central or distributed manner. For example, each smartphone could execute a corresponding resource management application that allows identifying other smartphones that belong to a partnered smartphone group and forming an ad-hoc or managed network for combining and or sharing resources necessary to enable the disassembly of a content stream into content segments, conveying of the content segments by the partnered smartphone group, and reassembly of the content segments into a content stream playable by a media player according to the present invention.

In accordance with one example of the invention, a content (e.g., a movie) provided by a content source is subdivided (or multiplexed) into multiple content portions that are conveyed to the smartphones of the partnered smartphone group via respective first wired or wireless communications links. The smartphones then convey the multiple content portions to the media player via respective second wired or wireless communications links. The smartphones may interface directly with the media player provided that it has partnered smartphone control capability or may instead interface with a partnered media control box that demultiplexes (i.e., recombines) the multiple content portions back into the content.

Smartphone Sharing Groups

Under one arrangement, a smartphone sharing group can be created or established (i.e., identified), where a smartphone sharing group is a group of people who in advance of a media streaming event have mutually agreed to allow their smartphones to be used to establish one or more partnered smartphone groups when required to support a media streaming event. As such, the smartphone sharing group defines specific smartphones that are eligible to partner in media streaming events. By establishing a smartphone sharing group, various parameters or attributes related to the smartphones of the members of the group can be leveraged in advance of a media streaming event in order to optimize the overall performance of a partnered smartphone group established using smartphones of the smartphone sharing group. For example, different smartphones may have different media streaming capabilities including having different cellular service providers, operating systems, memory storage, and so on, as is further described below, which could be stored in a partnership profile to be used when the smartphones in the group participate in the streaming event. One skilled in the art will recognize that storing such information in the partnership profile prior to a media streaming event enables planning and corresponding actions to be taken such as preprocessing of subdivided content. Thus, a smartphone sharing group defines smartphones for use in a partnered smartphone group, where a partnered smartphone group can be a group of smartphones of the smartphone sharing group used for streaming of multiplexed media content.

A given partnered smartphone group established to support a media streaming event can be a subset of smartphones belonging to members of a smartphone sharing group or could involve all the smartphones of the smartphone sharing group. Specifically, a group of N persons (e.g., friends, family members, employees, patrons, or the like) can be identified as being members of a smartphone sharing group having smartphones from which a partnered smartphone group including smartphones of M of the N persons can be established to support a media streaming event. The group of N persons in the smartphone sharing group and their respective smartphones can be established in many different ways, for example, the N persons might be the members of a family plan offered by a cellular phone service or other service, whereby the smartphone sharing group consists of the smartphones that are being provided with the service. A smartphone sharing group could correspond to employees of a company or a subset thereof (e.g., Senior Management), where the N persons might be identified via an administrator entity who sets up user accounts, group access, and the like. Under such an arrangement, a given person and associated smartphones might be able to participate in multiple smartphone sharing groups (e.g., employees smartphone sharing group, accounting employees smartphone sharing group, management smartphone sharing group, etc.). Generally, those persons in a smartphone sharing group (or smartphone partnering group) would have at least one smartphone associated with their membership and the phone number(s) of their respective smartphones would be information known to an administrative function that would be used to establish a partnered smartphone group to support a media streaming event.

Under one arrangement, prior to a media streaming event (e.g., a live broadcast), two or more smartphones belonging to one or more members of a smartphone sharing group can be selected to participate in a partnered smartphone group established to support a media streaming event. Under an alternative arrangement, during a media streaming event, two or more smartphones belonging to one or more members of a smartphone sharing group can join together to establish a partnered smartphone group to support the media streaming event. Optionally, one or more smartphones may be added to and/or subtracted from a previously established partnered smartphone group during a media streaming event.

Accordingly, a method for delivering content from a content source to a content player comprises establishing a partnered smartphone group comprising a plurality of smartphones belonging to a plurality of smartphone users that joined a smartphone partnering group thereby authorizing use of their respective smartphones in a partnered smartphone group for delivering content from a content source to a content player. The partnered smartphone group is associated with a content source via a first plurality of data links and is associated with a content player via a second plurality of data links. Subdividing of the content stream into a plurality of content segments delivering them from the content source to the partnered smartphone group via the first plurality of data links and delivering the content segments from the partnered smartphone group to a content player via the second plurality of data links. The recombining of the plurality of content segments enables the content player to play the recombined version of the transmitted content stream.

Ad Hoc Partnered Smartphone Groups

Under an alternative arrangement, a smartphone partnering group can be established ad hoc (i.e., without a smartphone sharing group being previously established). For example, an individual may establish or initiate a partnered smartphone group and then allow others to join the group ad hoc. With this approach, when a smartphone that is previously unknown to a partnered smartphone group joins the group during a media streaming event then information about that smartphone must be added to the partnership profile during the media streaming event in order to configure and manage the smartphone as a streaming resource of the group. As such, the amount of preplanning and preprocessing of content may be limited depending on how the ad hoc partnering process is managed. For example, content may preprocessed under an assumption or rule that some number of smartphones (or some amount of smartphone resources) will or must be added to a partnered smartphone group to support a content streaming event without knowing which smartphones will join the partnered smartphone group. If a previously unknown smartphone joins a partnered smartphone group prior to a media streaming event then some preplanning and preprocessing of content based upon information about that smartphone can be performed.

Application Software

Any of many well known methods can be used to establish a group of persons who have agreed to allow their smartphones to be used for partnered data streaming or to establish a partnered smartphone group. Under one arrangement, persons may join a smartphone sharing group or partnering group via a software application (i.e., a program), for example running on their smartphones, which might involve entering an identifier (or pass code). Persons may join smartphone sharing groups or partnered smartphone groups via an Internet application(s) much like joining a chat room or blog or may otherwise identify their availability to join a smartphone sharing group or partnered smartphone group. Persons may identify a group of people that they are allowing (or authorize) to participate in a smartphone sharing group. Generally, application software may include smartphone sharing group and/or smartphone partnering group functions that enable someone to manage the people and their smartphones to be included in one or more smartphone sharing groups, for example by selecting contacts from a Contact database. Such software may reside on a smartphone, on a computer, on a partnered media control box, and/or on a media player. Such software may also reside at a server and/or a content provider.

Partnered Smartphone Group Management

Information pertaining to the smartphones then participating as part of a partnered smartphone group that is included in a partnership profile can be used to configure and manage the communications links of the partnered smartphone group and the multiplexing and demultiplexing of content conveyed by their communications links. Such information would typically include information about the smartphone such as the phone number of the phone, smartphone type, memory storage size, operating system version, application software version, and the like. Such information may also include information about the cellular service used by the smartphone such as the type of network, cellular link status information, etc. Moreover, smartphone status information can be monitored during a media streaming event such as the status of battery strength, signal strength, CPU usage, and memory usage, and whether the smartphone is moving or in a fixed location. Information about the location of a smartphone, which might be determined via a GPS or another position tracking system, can be used to monitor and even predict performance of streaming capabilities. For example, the fact that a smartphone is about to enter a tunnel as determined using position determination techniques could be used to reroute streamed content to one or more other smartphones in a partnered smartphone group prior to that smartphone entering a tunnel. The relative location information about the smartphones of a partnered smartphone group can also be used, for example, to determine whether the smartphones are co-located or distributed. Given that smartphone communications in accordance with the invention may involve wired links, local area wireless links, and/or cellular wireless links, and combinations thereof, then various information about the type of links being employed, the maximum capabilities of such links and the extent of usage of such links at any given time during a media streaming event can be used to manage the smartphone partnered group. Other information pertaining to the media content can also be used such as the media type (e.g., video, audio, VOIP, etc.), data format, content size, content source data rate, communication type (i.e., live or not), etc. Generally, one skilled in the art will recognize that optimization algorithms can be employed that leverage such information to manage how the smartphones and corresponding communications links are used and how content is multiplexed, processed, and distributed to the various smartphones participating in a partnered smartphone group, where such management may involve varying usage or the extent of usage of a given smartphone at a given time during the media streaming event.

The management software may enforce rules and procedures intended to control access to the content provided to the smartphones and corresponding media players to include implementation of parental access controls, providing password access control, encryption/decryption and/or other data security measures to protect information such as classified information, confidential information, proprietary information, and the like. Such management software may enforce digital rights management rules to prevent unauthorized distribution (or copying) of streamed media content.

The management software used to manage the partnered smartphone group during a media streaming event can be located at a server (or content provider), a partnered media control box (or media player having partnered media control functionality), and/or at smartphones participating in a media streaming event. More specifically, in accordance with the invention there are seven possible scenarios for where such management software may reside as indicated by an ‘X’ in the following table:

Location of Partnered Smartphone Group Management Software

| | | Control Box/Media |
|---|---|---|
| Server/Content provider | Smartphone | Player |
| X | X | X |
| X | X | |
| X | | X |
| X | | |
| | X | X |
| | X | |
| | | X |

Management software may be installed and reinstalled (i.e., updated) from time to time via various well known software installation methods such as downloads from an Internet site, installation from a media source (e.g., a Compact Disc or a thumb drive). Software installation to a smartphone may occur as part of joining a partnered smartphone group or smartphone sharing group. Joining a partnered smartphone group or smartphone sharing group may also involve installation of access control parameters used to grant permission to a smartphone at the time of the media streaming event.

Streaming Systems and Networks

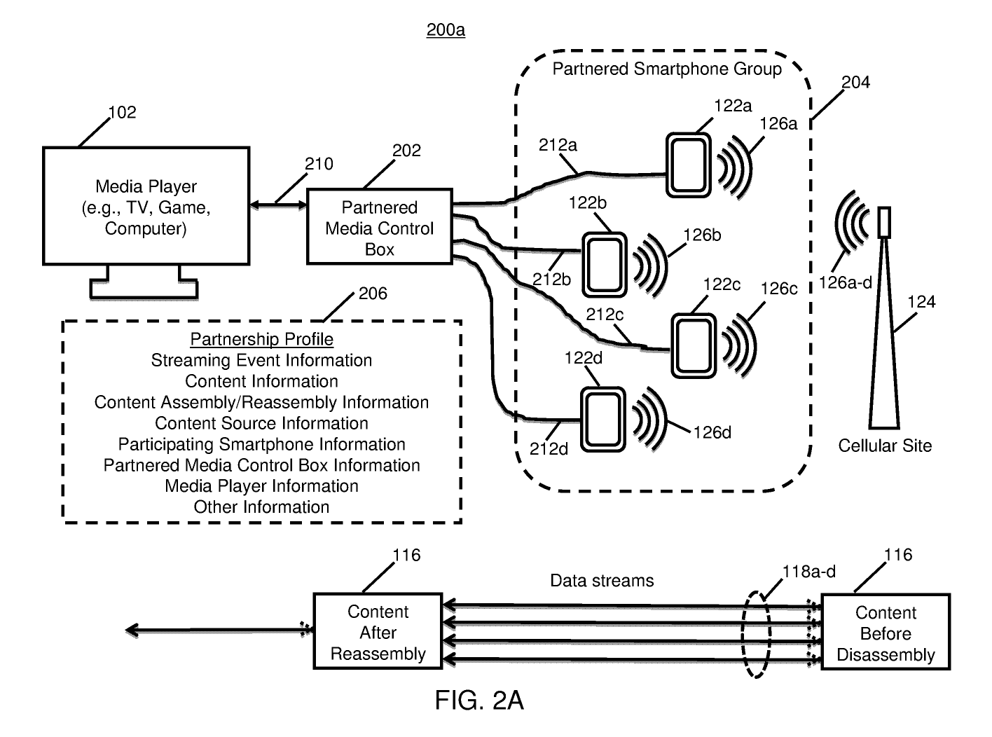

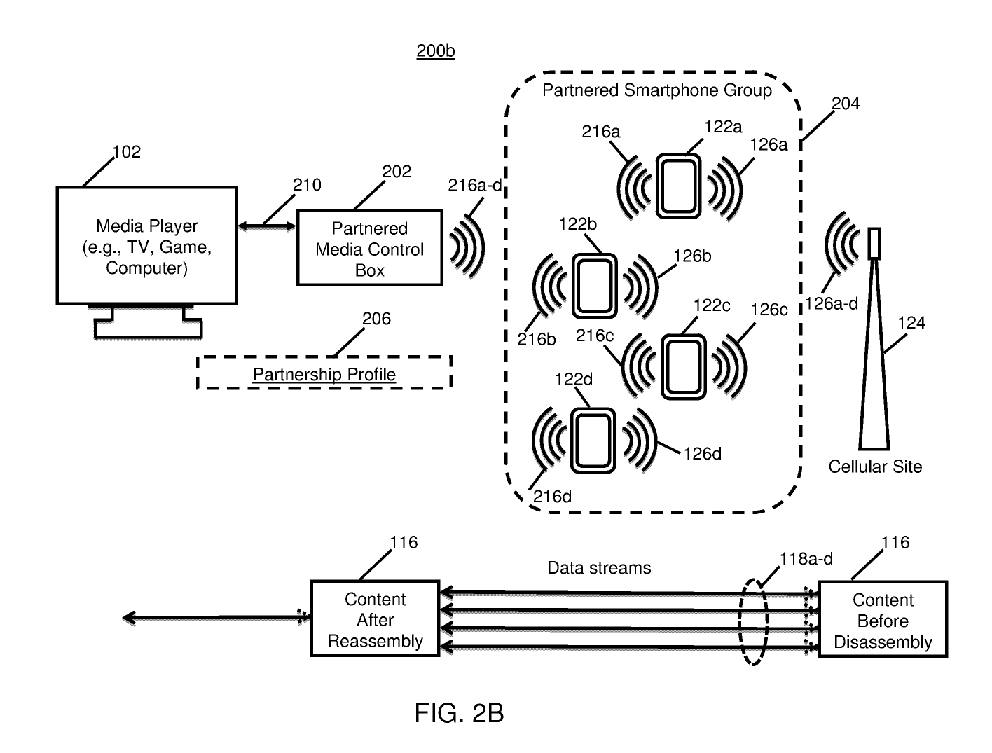

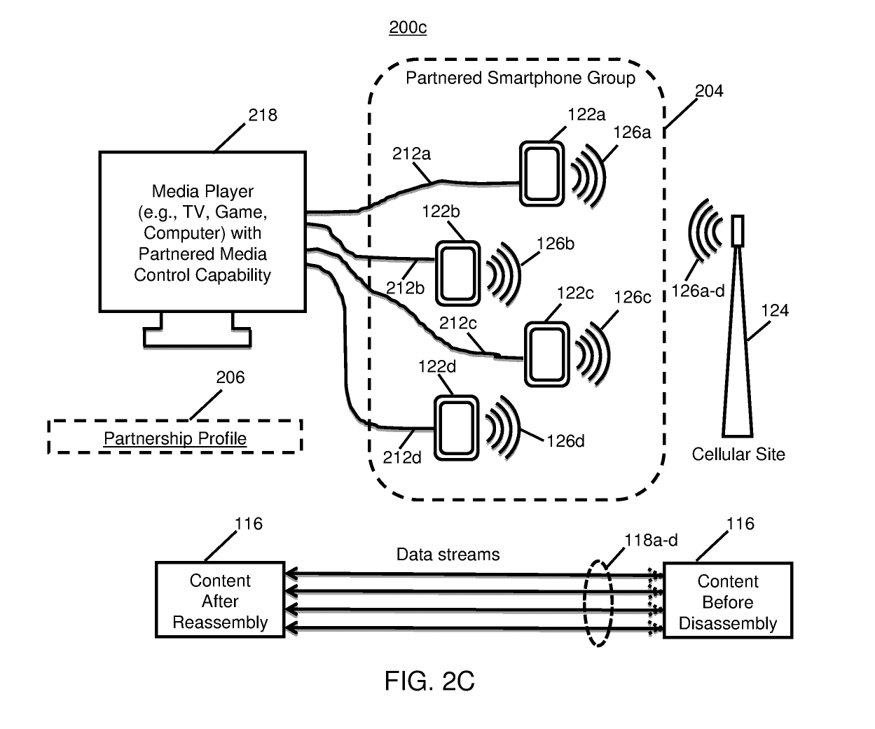

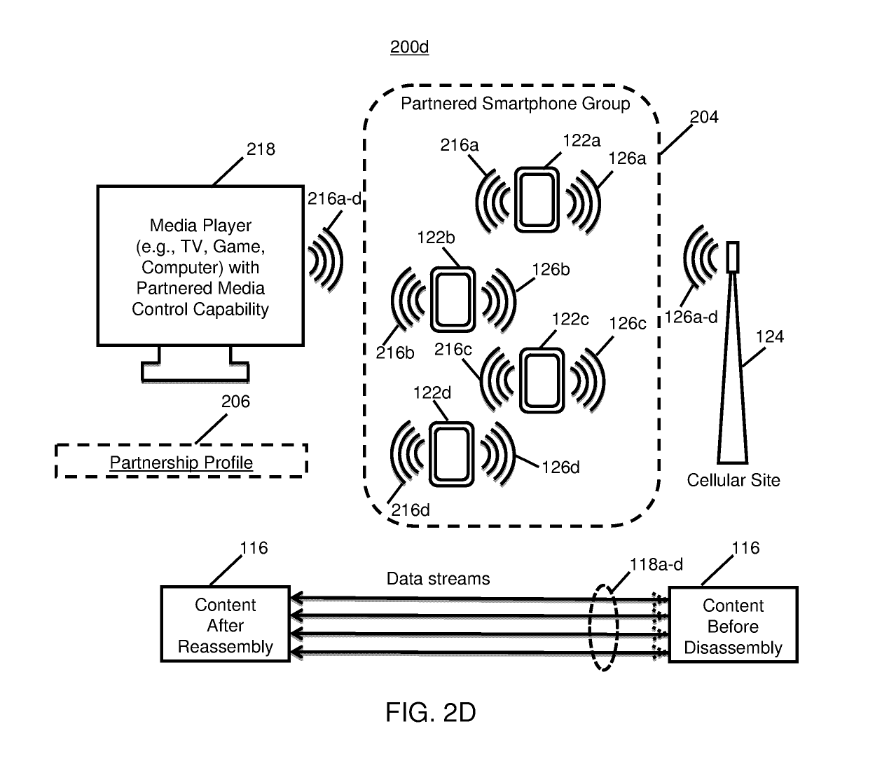

FIG. 2A depicts an exemplary streaming system 200a involving a partnered smartphone group 204 having resources configured and managed using a partnership profile 206, and a partnered media control box 202 used to provide high bandwidth data streaming between a media player 102 and a cellular site(s) 124 in accordance with one embodiment of the present invention. The partnership profile 206 typically comprises streaming event information, content information, content assembly/disassembly information, content source information, participating smartphone information, partnered media control box information, media player information, or other information (e.g., position information, accounting information, etc.). The smartphones 122a-122d are connected to the partnered media control box 202 via wired links 212a-212d, which can be any type of wired links such as Universal Serial Bus (USB), High Definition Multimedia Interface (HDMI), radio frequency (RF) coaxial cable, composite video, S-Video, SCART, component video, D-Terminal, or Video Graphics Array (VGA), or the like. The smartphones 122a-122d are also connected via respective cellular links 126a-126d to a content source, which provides a transmitted content stream. A content provider manages the content source and the infrastructure that generate transmitted content streams intended for the content media player 102. The content, e.g., audio, corresponding to transmitted content streams may for example be stored in content databases that are accessible by content servers that serve the transmitted content streams. Alternatively, a live content stream, e.g., a video chat, may be transmitted to the media player as soon as it is captured without accessing any content data bases.

The smartphones 122a-122d of the group 204 each receive all or a portion of the disassembled content segment 116 via respective data streams 118a-118d conveyed via respective cellular links 126a-126d, which are then conveyed to the partnered media control box 202 via their respective wired links 212a-212d. The received disassembled content sequence is demultiplexed or otherwise reassembled by a partnered media control box 202, which then provides the reassembled content to the media player 102 via another wired communications link 210 such as previously described in relation to wired links 212a-212d.

It should be noted that although a single cellular site 124 is depicted in FIG. 2A, multiple cellular sites can be involved in the media streaming system 200a. Moreover, any cellular technology can be used in accordance with the invention including Global System for Mobile Communications (GSM), General Packet Radio Service (GPRS), Code Division Multiple Access (CDMA), Enhanced Data Rates for GSM Evolution (EDGE), Wi-Fi, Wi-Max, 4G, and the like.

Additionally, the media streaming system 200a may optionally be capable of two-way communications in which case the control box 202 would multiplex returning content into portions and the content provider could demultiplex received portions into returned content. The returned content may originate from media player 102 and may be the same as the content after assembly 116 or be a modified version of the content after assembly 116. The content after assembly 116 may be modified by the media player 102 via input units coupled to or part of the media player 102. Examples of input units coupled to the media player 102 are, for example, but not limited to, a game controller, a key board, a joystick, a camera, a microphone.

Furthermore, although four smartphones are shown in the group 204, any number of multiple smartphones could be employed provided that sufficient communications links are available between the smartphones 122 and the control box 202. Because the smartphones 122a-122d of the partnered smartphone group 204 depicted in FIG. 2A are physically wired to the partnered media control box 202, they would typically be located within close proximity to the control box 202. Also, although only one is shown, multiple media players 102 can be connected to a partnered media control box 202.

The exemplary streaming system 200a of FIG. 2A lends itself to all sorts of scenarios whereby a group of individuals all connect their smartphones to a partnered media control box thereby establishing a smartphone group used to receive (and/or optionally transmit) multiplexed content from (and/or optionally to) content source via a cellular network. Example scenarios include a group of people on a camping trip in the wilderness receiving a high definition broadcast of a sporting event or movie, a group of soldiers within a field command center receiving high bandwidth Command, Control, Communications, Computers, and Intelligence (C4I) information, etc.

FIG. 2B depicts an alternative exemplary streaming system 200b involving a partnered smartphone group 204 having resources configured and managed using a partnership profile 206, and a partnered media control box 202 used to provide high bandwidth data streaming between a media player 102 and a cellular site(s) 124 in accordance with the present invention, where the smartphones 122a-d are connected to the partnered media control box via local area (e.g., short range) wireless links 216a-216d instead of wired links 212a-212d. Such local area wireless links may require line-of-sight, such as an infrared optical link, or may use any other well-known wireless links such as Bluetooth, WiFi, UWB, and the like. Because the streaming system 200b of FIG. 2B employs local area wireless links between the smartphones 122a-122d and the partnered media control box 202, the smartphones must only be in range of the partnered media control box 202 to function as part of the partnered smartphone group 204 and therefore may not be in close enough proximity to the control box 202 to enable a wired connection. Alternatively, should one or more of the smartphones 122a-122d in the partnered smartphone group 204 be in close proximity to the partnered media control box 202 one or more of those phones could connect to the partnered media control box via a wired connection while the other smartphones in the group use wireless connections, which would be a combination of connectivity depicted in FIGS. 2A and 2B. Clearly, various combinations of the wired links 212 and local area wireless links 216 are possible depending on the relative locations of the smartphones in the partnered smartphone group and the partnered media control box.

The wireless multiplexing/demultiplexing capability depicted in FIG. 2B lends itself to scenarios whereby mobility of the smartphones is a requirement, for example, players of a position-based game moving about a park, soldiers on patrol, patrons at a restaurant, or family members moving about a home.

FIG. 2C depicts an exemplary streaming system 200c involving a partnered smartphone group 204 having resources configured and managed using a partnership profile 206 that is used to provide high bandwidth data streaming between a media player having partnered media control capability 218 and a cellular site(s) 124 in accordance with the present invention, where the smartphones 122a-122d are connected to the media player 218 via wired links 212a-212d. As such, the streaming system 200c of FIG. 2C is the same as that of FIG. 2A except the functionality of the control box 202 is included in the media player 218, which interfaces directly with the smartphones 122a-122d of the partnered smartphone group 204.

FIG. 2D depicts an exemplary streaming system involving a partnered smartphone group 204 having resources configured and managed using a partnership profile 206 that is used to provide high bandwidth data streaming between a media player having partnered media control capability 218 and a cellular site(s) 124 in accordance with the present invention, where the smartphones 122a-122d are connected to the media player 218 via local area wireless links 216a-216d. As such, the streaming system 200d of FIG. 2D is the same as that of FIG. 2B except the functionality of the control box 202 is included in the media player 218, which interfaces directly with the smartphones 122a-122d of the partnered smartphone group 204.

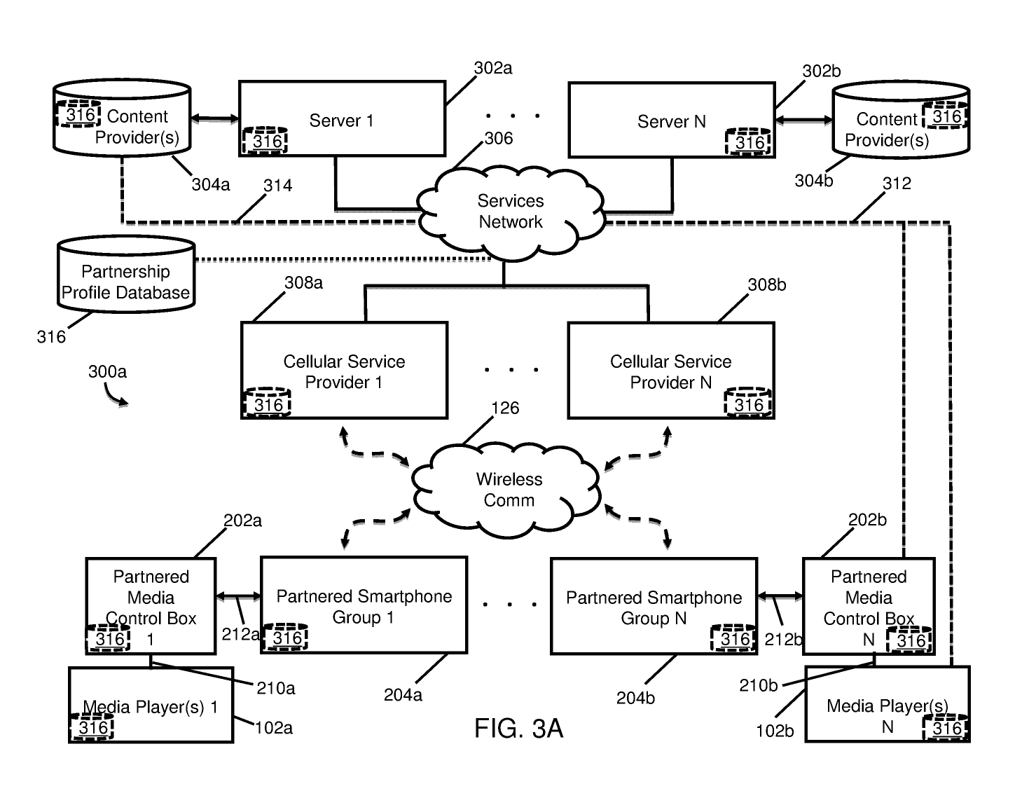

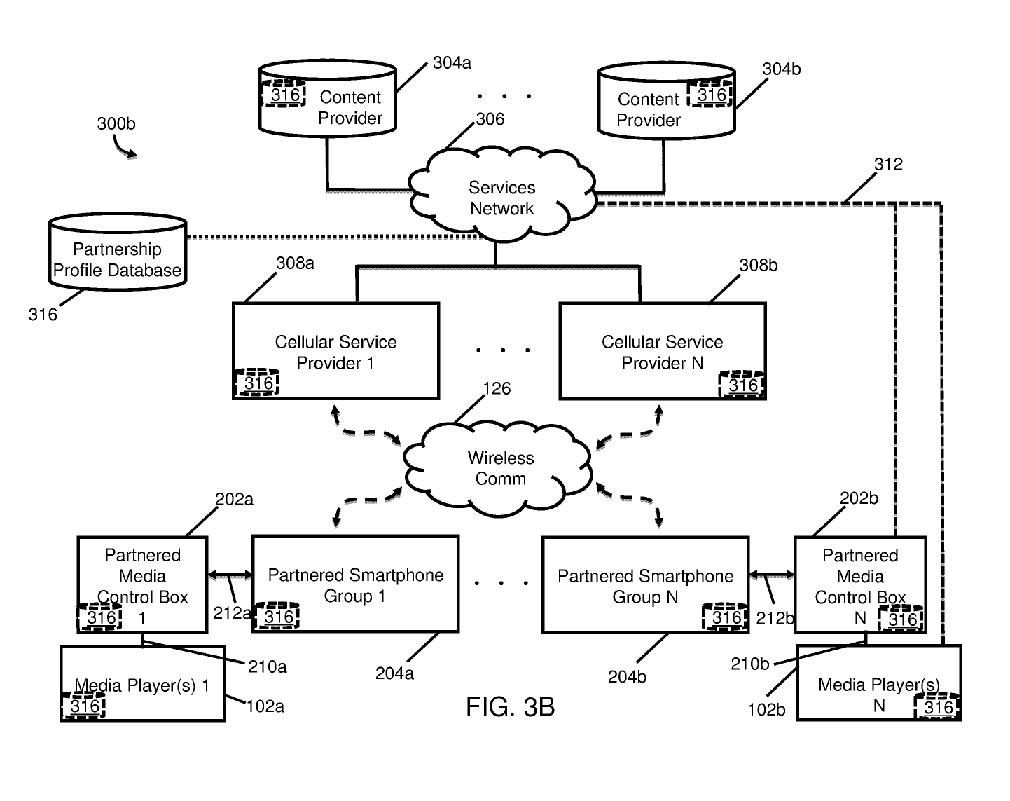

FIG. 3A depicts an exemplary network 300a enabling content to be delivered to media players 102a 102b (or, alternatively, a Media Player with Partnered Media Control Capabilities 218) via cellular wireless communications links 126 and partnered smartphone groups 204 each having resources configured and managed using a partnership profile stored in a partnership profile database 316 in accordance with the present invention, where multiplexed content is provided to smartphones of a partnered smartphone group 204 via servers 302 that receive the multiplexed content from content providers 304. Referring to FIG. 3A, network 300a comprises one or more servers 302 that receive content from content providers 304. The servers 302 are connected to a services network 306, e.g., a wide area network and typically the Internet, to which one or more cellular service providers 308 are also connected. The partnership profile database is shown connected to the services network 306 but alternatively could be located at one location or distributed at multiple locations within the network 300a as indicated by the dashed partnership profile database symbols 316. The cellular service providers 308 interface with the partner smartphone groups 204 via a wireless communications infrastructure 126, which includes cellular sites, switching networks, and the like. The partnered smartphone groups 204 interface with the media players 102 with or without using a partnered media control box 202, as previously described. Thus, a server 302, a partnered smartphone group 204, and optionally a partnered media control box 202 may collaborate to stream content from a server 302 to a media player 102. One skilled in the art will recognize that various approaches are possible for configuring and managing the streaming event as is described in greater detail below.

Optional interfaces 312 between a media player 102 and/or a partnered media control box 202 and the service network 306 as well as optional interfaces 314 between the content providers 304 and the services network 306 can also be used to enable persons to subscribe to services, manage resources, and the like, or for direct media streaming between the content provider and the media player without use of a server. For example, a user of a media streaming system 200d in accordance with the invention might log onto a service provided by a content provider 304 or by a server 302 via the Internet to schedule a media streaming event, to identify smartphones of group members, etc. One skilled in the art will recognize that the concept of servers and content providers can generally represent multiple layers of content providers to include the original content provider (e.g., a television network, a movie studio, a recording studio, etc.) and servers of their content (e.g., a movie rental service), where there could be additional layers beyond the two layers depicted. Moreover, media streaming can occur between both content providers 304 and media players 102 and servers 302 and media players 102. Generally, all sorts of combinations are possible to convey one or more content from one or more content sources to one or more media players 102 via one or more smartphone groups 204.

FIG. 3B depicts an exemplary network 300b enabling content to be delivered to media players 102 via cellular wireless communications links 126 and partnered smartphone groups 204 each having resources configured and managed using a partnership profile stored in a partnership profile database 316 in accordance with the present invention, where multiplexed content is provided from content providers 304 (i.e., without servers 302). The partnership profile database is shown connected to the services network 306 but alternatively could be located at one location or distributed at multiple locations within the network 300a as indicated by the dashed partnership profile database symbols 316. As such, the network 300b of FIG. 3B is the same as the network 300a of FIG. 3A except servers 302 are not present, whereby for a given media streaming event, a content provider 304, a partnered smartphone group 204, and a partnered media control box 202 collaborate to stream content from the content provider 304 to a media player 102.

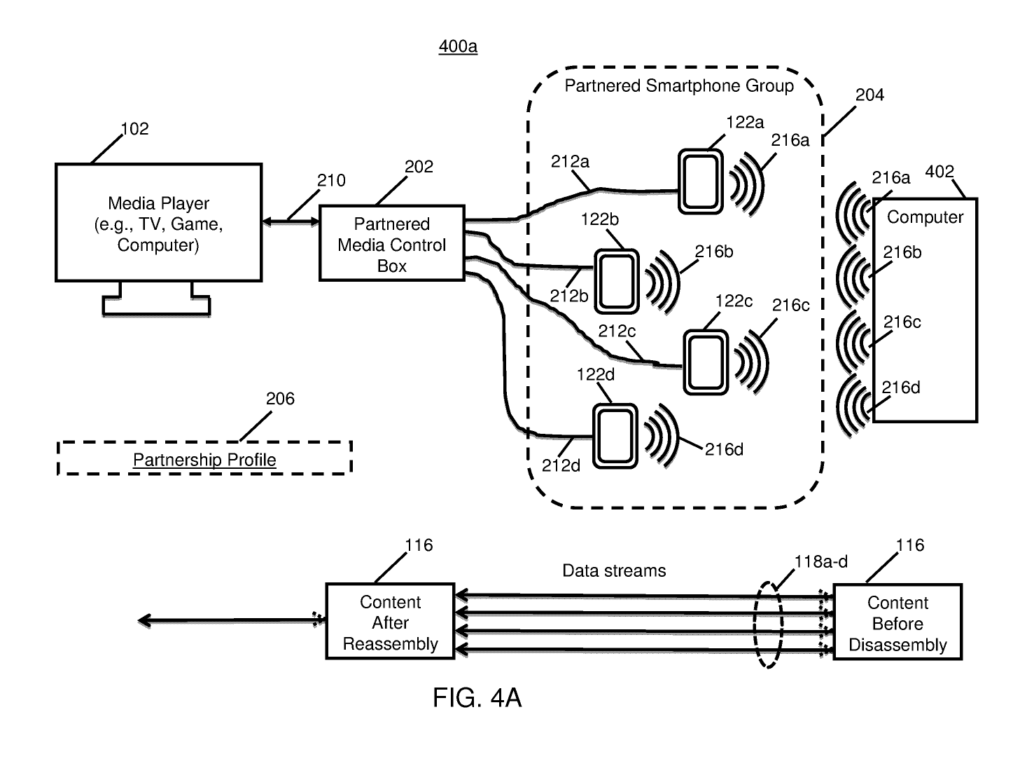

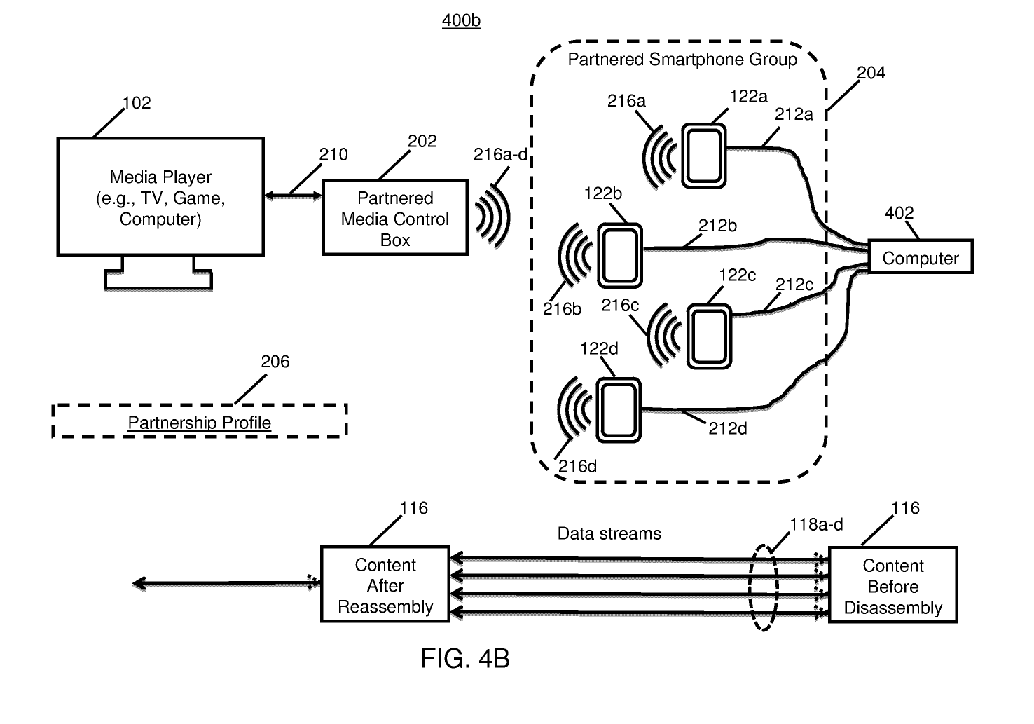

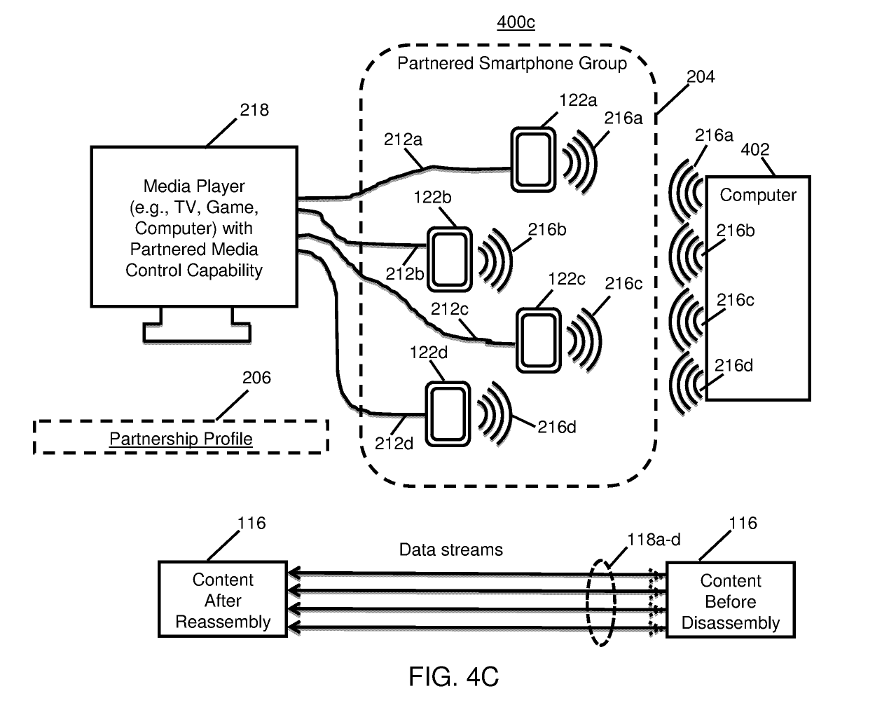

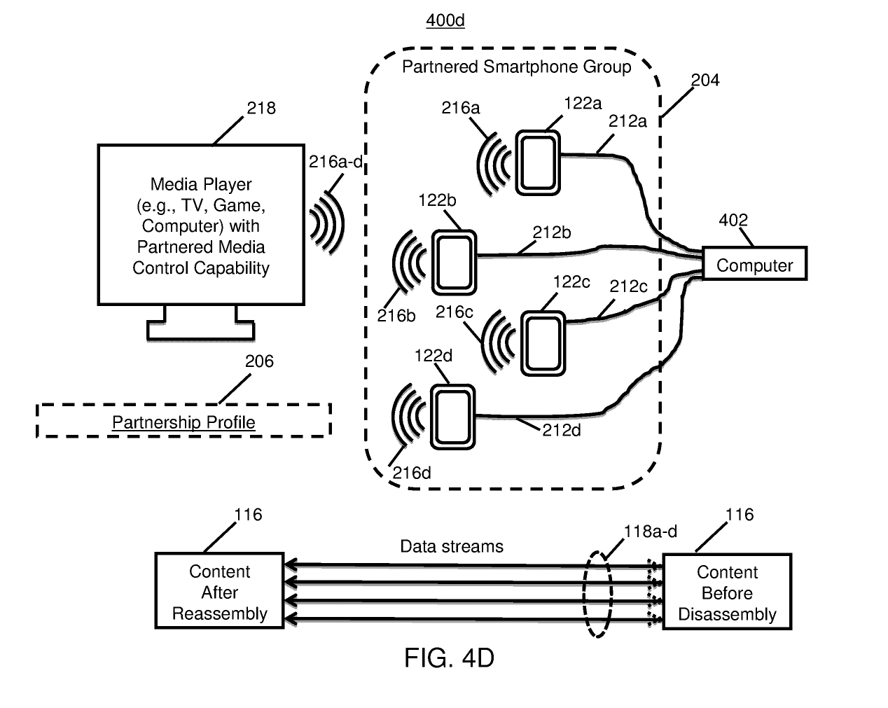

The network 300 of FIG. 3B might be useful for live media streaming where use of a server might be impractical, for example, streaming of a live feed from a musical concert, sporting event, or the like. Alternatively, should one or more of the smartphones 122a-122d in the partnered smartphone group 204 be in close proximity to the partnered media control box 202 one or more of those phones could connect to the partnered media control box 202 via a wired link 212 and connect to the computer 402 via a local area wireless link 216, which would be a combination of connectivity depicted in FIGS. 4A and 4B. Clearly, various combinations of the wired links 212 and local area wireless links 216 are possible depending on the relative locations of the smartphones in the partnered smartphone group 204, the partnered media control box 202, and the computer 402.

Multiplexing (or subdivision) of content into multiple content portions for conveyance as multiple data streams by a partnered smartphone group can be performed at a content provider 304, at a server 302, at a cellular service provider 308, at a partnered media control box 202, or at a media player having partnered media control capability 218. Likewise, when receiving multiplexed information from a media player having partnered media control capability 218 (or partnered media control box 202), demultiplexing (recombining) can be performed at a content provider 304, a server 302, a cellular service provider 308, a partnered media control box 202, or a media player having partnered media control capability 218.

Content can be subdivided into equal portions or unequal portions and content can be duplicated and distributed among multiple portions to support error correction due to packet loss. Generally, all sorts of well-known forward error correction (FEC) techniques can be employed to enable errors to be corrected without requesting retransmission of a packet. Subdivided content can be sequenced in all sorts of ways, for example, if subdivided into two data streams, content could be subdivided every other bit, every other N bits, in half, two-thirds to one stream and one-third to the other, etc. Any desirable subdivision/sequencing approach can be employed within the scope of the invention such as a dynamic approach based on resource availability and/or other factors. Moreover, content subdivision can be performed ‘in real time’, i.e., at the time of a media streaming event, or content portions may be ‘prepackaged’ thereby enabling data processing relating to packets (e.g., FEC, encryption, data compression, etc.) to be performed prior to their use to support faster media streaming. Alternatively, data processing such as FEC, encryption, data compression and the like can be performed at the time of media streaming.

One skilled in the art will recognize that the exemplary networks 300a and 300b of FIGS. 3A and 3B can provide a plurality of different content to a plurality of media players via a plurality of cellular wireless communications links and a plurality of partnered smartphone groups in accordance with the present invention. For example, in network 300a, content 116a can be provided from a content source 304a to a first media player 102a via, for example, server 302a, service network 306, a cellular provider 308a 308b, wireless communication link 126, partnered smartphone group 1 204a and media control box 202a. Likewise, content 116b, which may be the same or different from content 116a, can be provided from content source 304b to media player N 102b via, for example, server 302b, service network 306, a cellular provider 308a 308b, wireless communication link 126, partnered smartphone group N 204b and partnered media control box N 202b. Furthermore, each of the systems and networks described elsewhere in this application are similarly able to provide a plurality of different content to a plurality of media players via one or more smartphone groups.

FIG. 4A depicts an exemplary streaming system 400a involving a partnered smartphone group 204 having resources configured and managed using a partnership profile 206, and a partnered media control box 202 used to provide high bandwidth data streaming between a media player 102 and a computer 402 in accordance with the present invention, where the smartphones 122a-122d are connected to the partnered media control box 202 via wired links 212a-212d and are connected to the computer 402 via local area wireless links 216a-216d. The computer 402 is capable of multiplexing (and optionally demultiplexing) content and has the ability to send (and optionally receive) content packets (i.e., content portions) over multiple communication links. The computer 402 may in turn be connected via a wire or wirelessly with another computer, a server, a content provider, or the computer may itself be a server of content. For example, the computer 402 could reside in a building (perhaps in close proximity to a parking lot where lots of football fans are tailgating) and could wirelessly stream to one or more partnered smartphone groups 204, where each group 204 is associated with a control box 202 and media player 102. For the example depicted in FIG. 4A, if one-to-many communications links are used (i.e., originating at the computer), the computer 402 could simultaneously convey four channels of subdivided content to multiple partnered smartphone groups 204 each involving four smartphones 122a-122d thereby enabling each group 204 to convey to their respective partnered media control boxes 202 the same subdivided content (e.g., four portions of a 1080i high definition video stream) that can then be reassembled by the control box 202 and presented by their respective media players 102. Similarly, content originating at the media player 102 can be subdivided by the partnered media control box 202 and the content portions conveyed via the partnered smartphone group 204 to the computer 402 where it could be reassembled. As with the system 200a of FIG. 2A, because with the system 400a of FIG. 4A the smartphones 122a-122d of the partnered smartphone group 204 are physically wired to the partnered media control box 202, they would typically be located within close proximity to the control box 202.

FIG. 4B depicts an exemplary streaming system 400b involving a partnered smartphone group 204 having resources configured and managed using a partnership profile 206, and a partnered media control box 202 used to provide high bandwidth data streaming between a media player 102 and a computer 402 in accordance with the present invention, where the smartphones 122a-122d are connected to the partnered media control box 202 via local area wireless links 216a-d and are connected to the computer 402 via local area wired links 216a-216d. As such, the steaming system 400b of FIG. 4B functions just like the streaming system 400a of FIG. 4A except that local area wireless links 216a-216d are used between the smartphones 122a-122d and the partnered media control box 102 instead of between the smartphones 122a-122d and the computer 402 and local area wired links 216a-216d connect the smartphones 122a-122d to the computer 402 instead of the partnered media control box 202. As with the system 200b of FIG. 2B, because with the smartphones 122a-122d of the partnered smartphone group 204 of the system 400b FIG. 4B are physically connected (e.g., wired) to the computer 402, they would typically be located within close proximity to the computer 402.

FIG. 4C depicts an exemplary streaming system 400c involving a partnered smartphone group 204 having resources configured and managed using a partnership profile 206 used to provide high bandwidth data streaming between a media player having partnered media control capability 218 and a computer 402 in accordance with the present invention, where the smartphones 122a-122d are connected to the media player having partnered media control capability 218 via wired links 212a-212d and are connected to the computer 402 via local area wireless links 216a-216d.

FIG. 4D depicts an exemplary streaming system 400d involving a partnered smartphone group 204 having resources configured and managed using a partnership profile 206 used to provide high bandwidth data streaming between a media player having partnered media control capability 218 and a computer 402 in accordance with the present invention, where the smartphones 122a-122d are connected to the media player having partnered media control capability 218 via local area wireless links 216a-216d and are connected to the computer 402 via wired links 212a-212d.

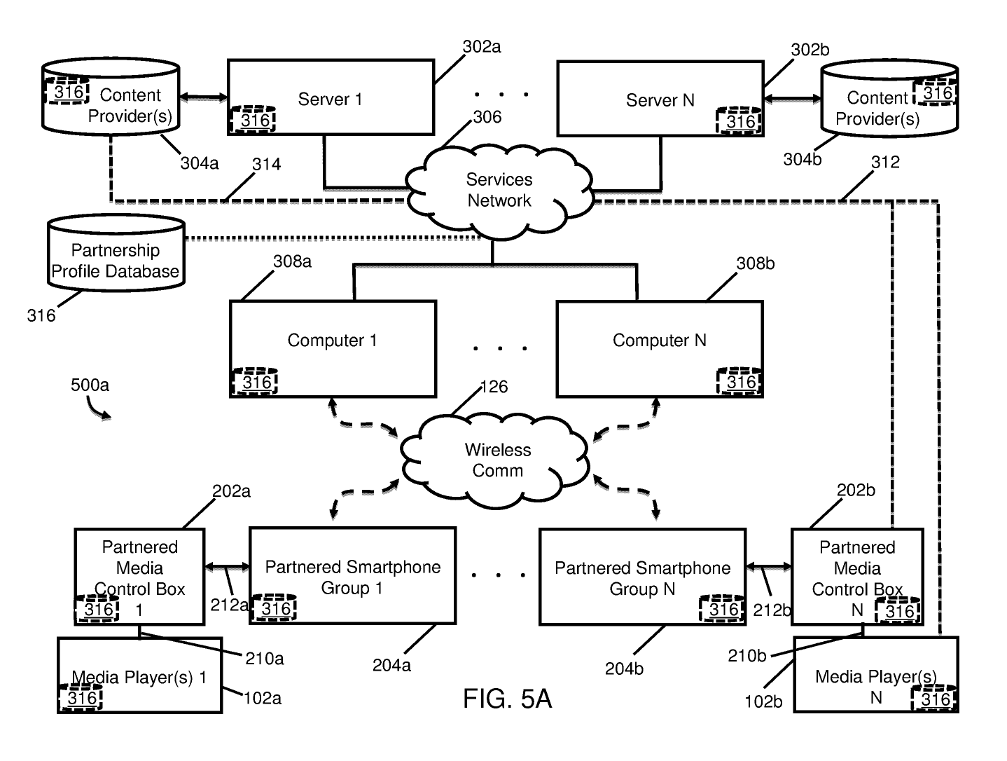

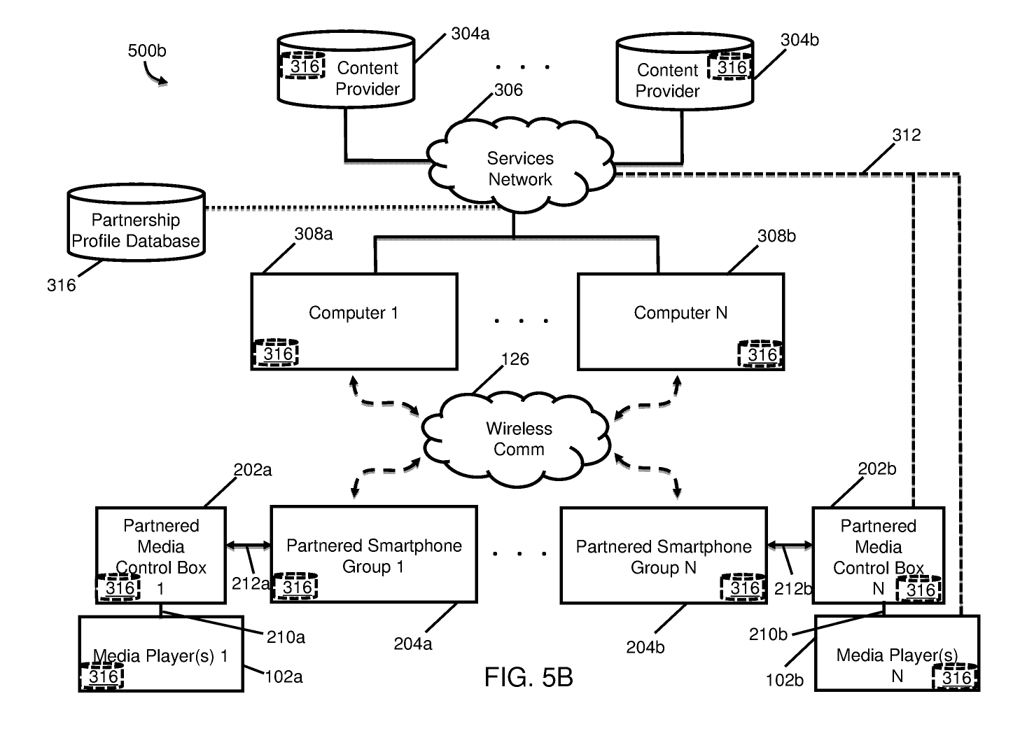

FIG. 5A depicts an exemplary network 500a enabling content to be delivered to media players via wireless communications links between a computer(s) 308 and partnered smartphone groups 204 each having resources configured and managed using a partnership profile stored in a partnership profile database 316 in accordance with the present invention, where the content is provided via servers 302 that receive content from content providers 304. The partnership profile database is shown connected to the services network 306 but alternatively could be located at one location or distributed at multiple locations within the network 300a as indicated by the dashed partnership profile database symbols 316. The network 500a of FIG. 5A is very similar to the network 300 of FIG. 3A except the partnered smartphone groups 204 interface via wireless communications with one or more computers 308 instead of with cellular service providers. The computers 308 are depicted being directly connected to a service network. Alternatively, a computer 308 could be connected to a cellular service provider that is connected to a services network as part of network 500a.

FIG. 5B depicts an exemplary network 500b enabling content to be delivered to media players via wireless communications links between a computer(s) 308 and partnered smartphone groups 204 each having resources configured and managed using a partnership profile stored in a partnership profile database 316 in accordance with the present invention, where the content is provided directly from content providers. The partnership profile database is shown connected to the services network 306 but alternatively could be located at one location or distributed at multiple locations within the network 300a as indicated by the dashed partnership profile database symbols 316. As such, the network 500b is comparable to the network 300b of FIG. 3B, whereby as with FIG. 5A, a computer 308 could alternatively be connected to a cellular service provider that is connected to a services network as part of network 500b.

In accordance with another aspect of the invention, partnered smartphone groups can interface with each other via local area wireless links and/or via cellular service providers. Various scenarios are supported by this embodiment of the invention such as wireless gaming whereby the smartphones could also serve as game controllers. Such wireless gaming could be between multiple groups of people within a restaurant or between multiple groups of people located almost anywhere on the planet.

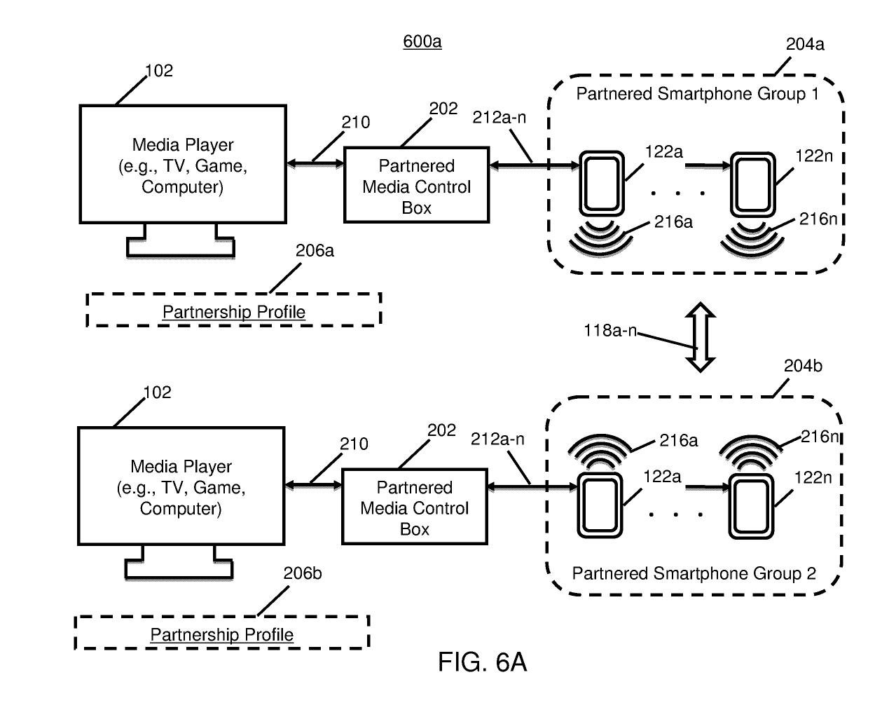

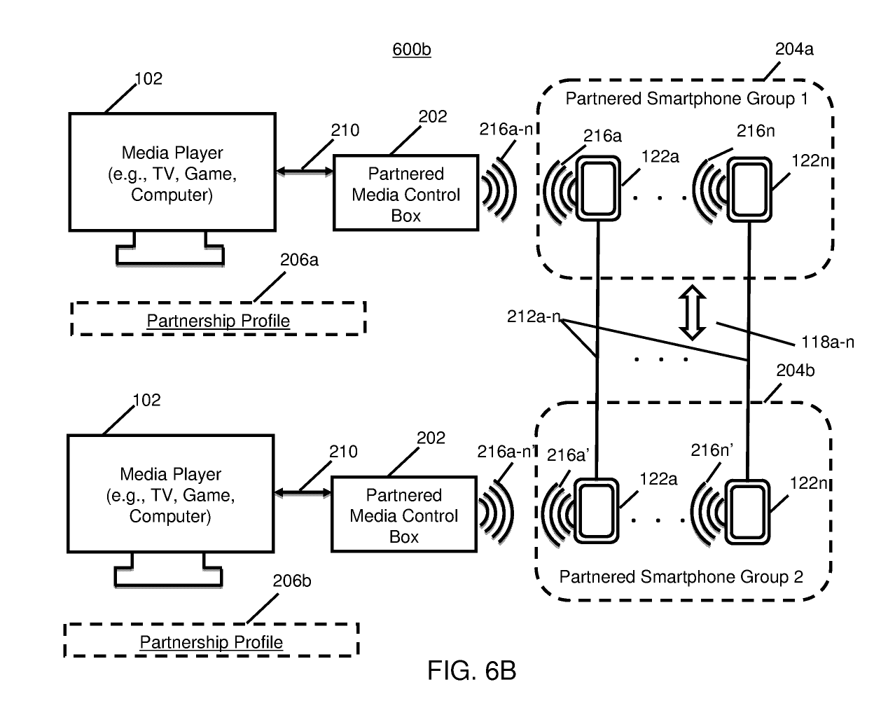

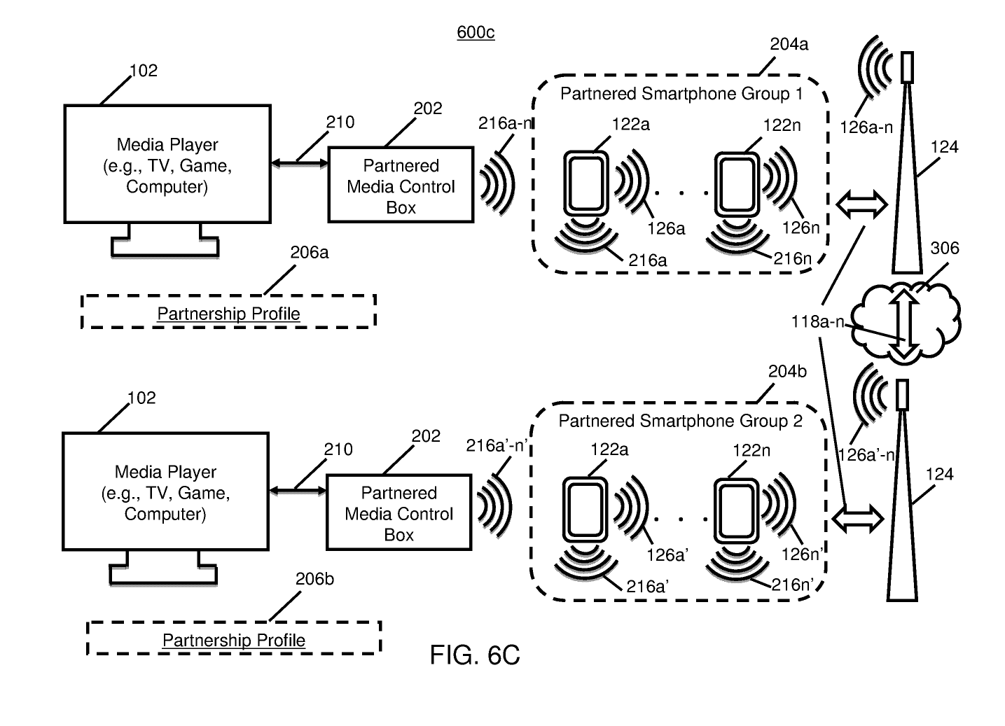

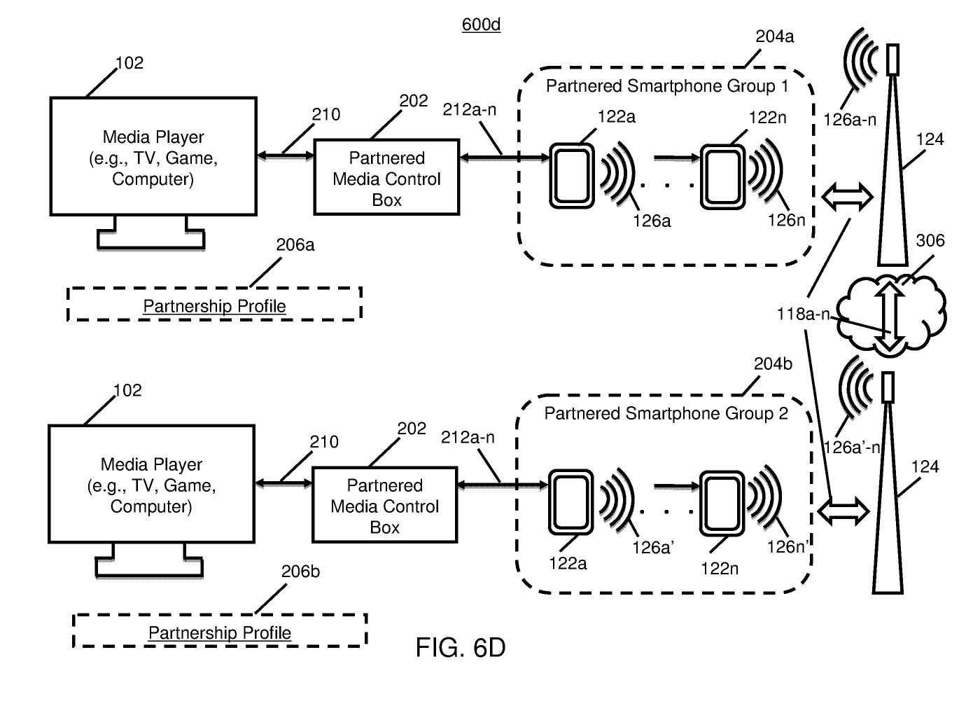

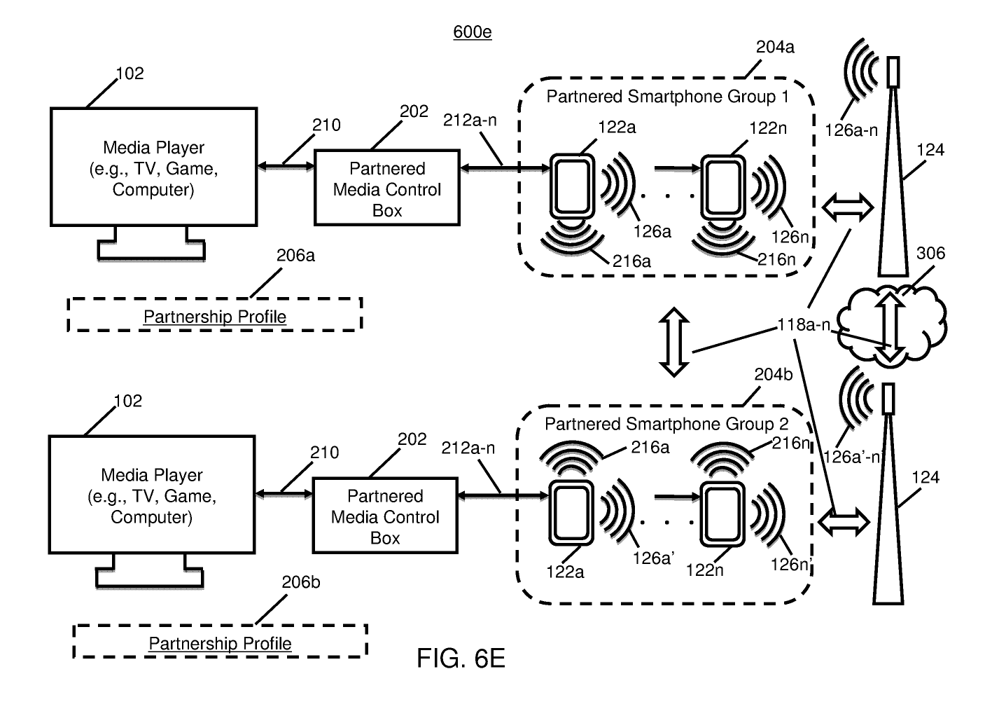

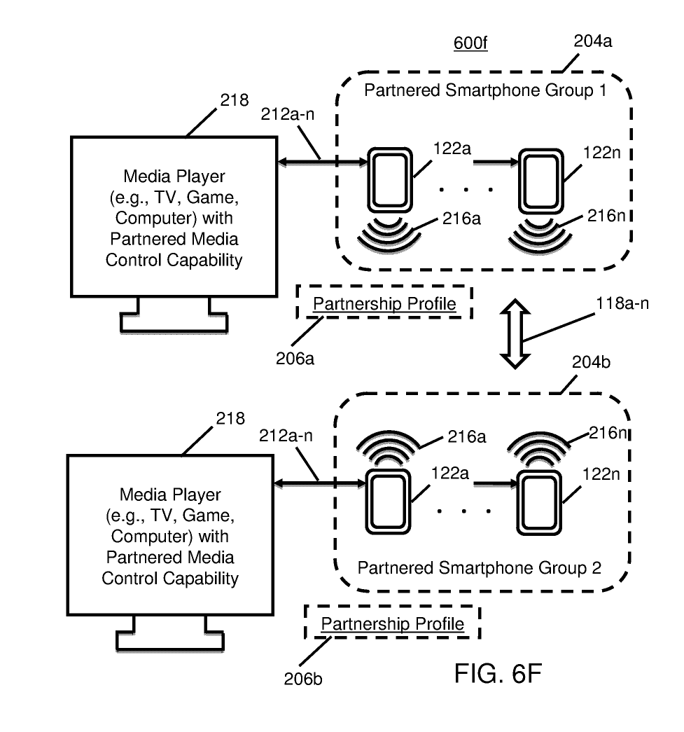

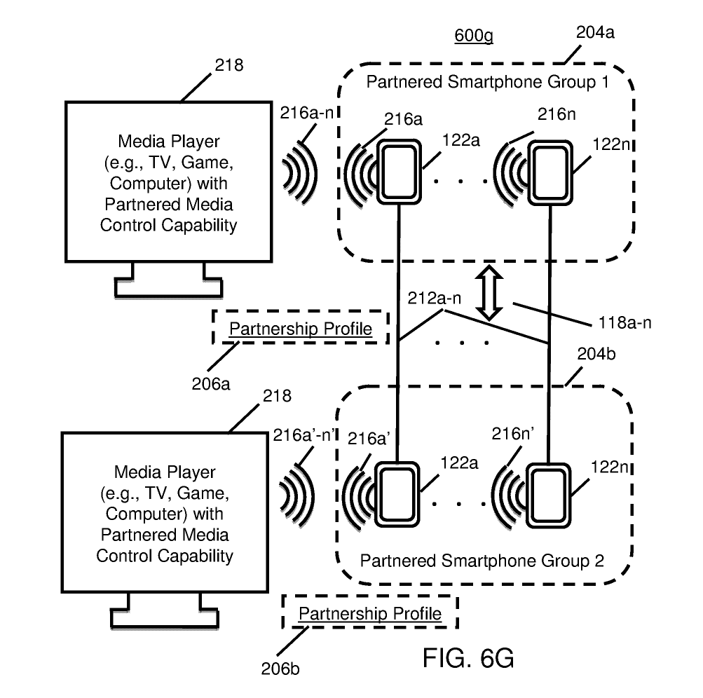

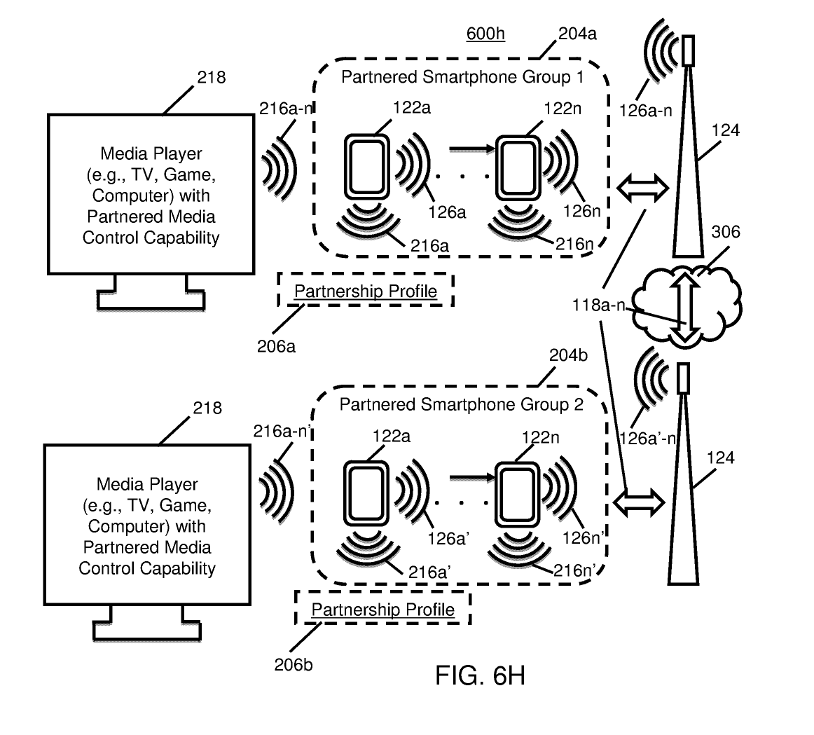

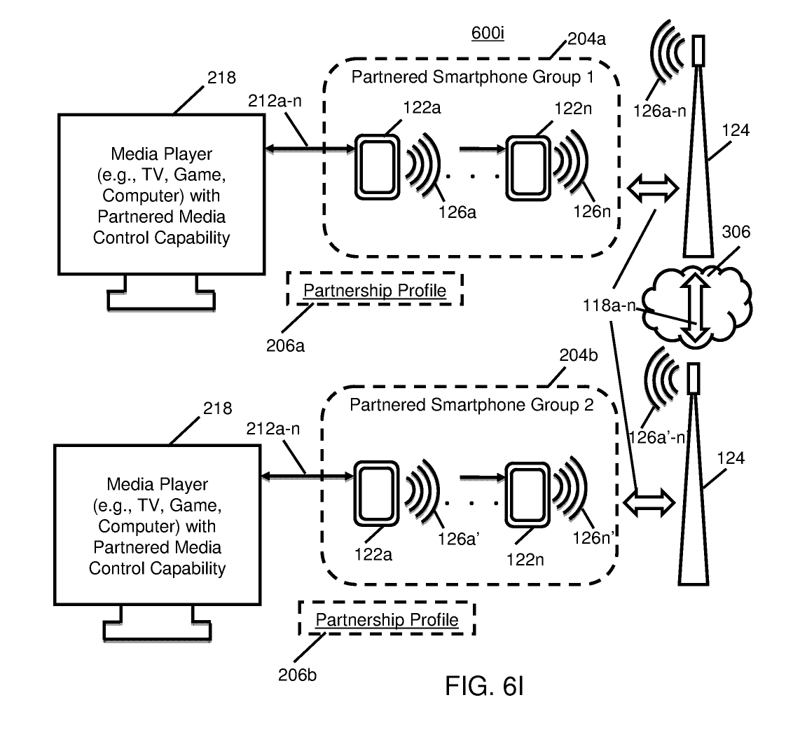

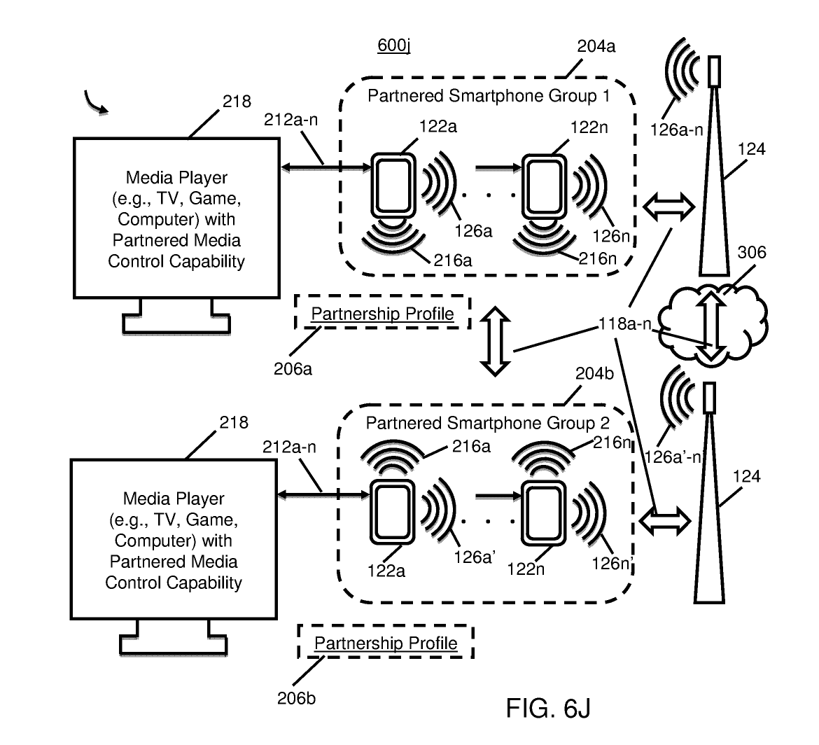

FIGS. 6A through 6J depict exemplary streaming systems involving two partnered smartphone groups providing high bandwidth data streaming between two media players in accordance with the present invention. One skilled in the art will recognize that more than two partnered smartphone groups can be employed to support high bandwidth data streaming between two (or more) media players in accordance with the present invention. Such media players may be gaming systems, collaborative meeting systems, command and control systems, and the like where the users of the smartphones benefit from the display (or playing) of content at the media player than could otherwise occur without the combined bandwidth (and other shared resources) of the smartphones comprising the partnered smartphone groups.

FIG. 6A depicts an exemplary streaming system 600a involving two partnered smartphone groups 204a 204b having resources configured and managed using respective partnership profiles 206a 206b to provide high bandwidth data streaming between two media players 102 in accordance with the present invention, where the smartphones 122a-122n of the multiple partnered smartphone groups 204a-204n are connected to respective partnered media control boxes 202 via wired links 212a-212n and to each other via local area wireless links 216a-216n. As such, multiple data streams 118a-118n are used to exchange high bandwidth data between the two partnered smartphone groups 204a 204b.

FIG. 6B depicts an exemplary streaming system 600b involving two partnered smartphone groups 204a 204b having resources configured and managed using respective partnership profiles 206a 206b to provide high bandwidth data streaming between two media players 102 in accordance with the present invention, where the smartphones 122a-122n of the two partnered smartphone groups 204a-204b are connected to respective partnered media control boxes 202 via wireless links 216a-216n 216a′-216n′ and to each other via wired links 212a-212n. As such, multiple data streams 118a-118n are used to exchange high bandwidth data between the two partnered smartphone groups 204a 204b.

FIG. 6C depicts an exemplary streaming system 600c involving two partnered smartphone groups 204a 204b having resources configured and managed using respective partnership profiles 206a 206b to provide high bandwidth data streaming between two media players 102 in accordance with the present invention, where the smartphones 122a-122n of the multiple partnered smartphone groups 204a-204n are connected to respective partnered media control boxes 202 via local area wireless links 216a-216n 216a′-216n′ and to each other via cellular wireless links 126a-126n 126a′-126n′. One skilled in the art will recognize that when conferencing capabilities are employed between smartphones that all sorts of combinations are possible for high data rate streaming between two (or more) partnered smartphone groups 204a 204b.

FIG. 6D depicts an exemplary streaming system 600d involving two partnered smartphone groups 204a 204b having resources configured and managed using respective partnership profiles 206a 206b to provide high bandwidth data streaming between two media players 202 in accordance with the present invention, where the smartphones 122a-122n of the multiple partnered smartphone groups 204a-204n are connected to respective partnered media control boxes 202 via wired links 212a-212n and to each other via cellular wireless links 126a-126n 126a′-126n′.

FIG. 6E depicts an exemplary streaming system 600e involving multiple partnered smartphone groups 204a 204b having resources configured and managed using respective partnership profiles 206a 206b to provide high bandwidth data streaming between multiple media players 202 in accordance with the present invention, where the smartphones 122a-122n of the multiple partnered smartphone groups 204a-204n are connected to respective partnered media control boxes 202 via wired links 212a-212n and to each other via local area wireless links 216a-216n and cellular wireless links 126a-126n 126a′-126n′.

FIG. 6F depicts an exemplary streaming system 600f involving multiple partnered smartphone groups 204a 204b having resources configured and managed using respective partnership profiles 206a 206b to provide high bandwidth data streaming between multiple media players having partnered media control capability 218 in accordance with the present invention, where the smartphones 122a-122n of the multiple partnered smartphone groups 204a 204b are connected to respective media players 218 via wired links 212a-212n and to each other via local area wireless links 216a-216n. The streaming system 600f of FIG. 6F is the same as the streaming system 600a of FIG. 6A except the functionality of the media player 102 and external partnered media control box 202 are combined.

FIG. 6G depicts an exemplary streaming system 600g involving two partnered smartphone groups 204a 204b having resources configured and managed using respective partnership profiles 206a 206b to provide high bandwidth data streaming between two media players having partnered media control capability 218 in accordance with the present invention, where the smartphones 122a-122n of the two partnered smartphone groups 204a 204b are connected to respective media players 218 via local area wireless links 216a-216n 216a′-216n′ and to each other via wired links 212a-212n. The streaming system 600g of FIG. 6G is the same as the streaming system 600b of FIG. 6B except the functionality of the media player 102 and external partnered media control box 202 are combined.

FIG. 6H depicts an exemplary streaming system 600h involving multiple partnered smartphone groups 204a 204b having resources configured and managed using respective partnership profiles 206a 206b to provide high bandwidth data streaming between multiple media players having partnered media control capability 218 in accordance with the present invention, where the smartphones 122a-122n of the multiple partnered smartphone groups 204a 204b are connected to respective media players 218 via local area wireless links 216a-216n 216a′-216n′ and to each other via cellular wireless links 126a-126n 126a′-126n′. The streaming system 600h of FIG. 6H is the same as the streaming system 600c of FIG. 6C except the functionality of the media player 102 and external partnered media control box 202 are combined.

FIG. 6I depicts an exemplary streaming system 600i involving multiple partnered smartphone groups 204a 204b having resources configured and managed using respective partnership profiles 206a 206b to provide high bandwidth data streaming between multiple media players having partnered media control capability 218 in accordance with the present invention, where the smartphones 122a-122n of the multiple partnered smartphone groups 204a 204b are connected to respective media players boxes 218 via wired links 212a-212n and to each other via cellular wireless links 126a-126n 126a′-126n′. The streaming system 600i of FIG. 6I is the same as the streaming system 600d of FIG. 6D except the functionality of the media player 102 and external partnered media control box 202 are combined.

FIG. 6J depicts an exemplary streaming system 600j involving multiple partnered smartphone groups 204a 204b having resources configured and managed using respective partnership profiles 206a 206b to provide high bandwidth data streaming between multiple media players having partnered media control capability 218 in accordance with the present invention, where the smartphones 122a-122n of the multiple partnered smartphone groups 204a 204b are connected to respective media players 218 via wired links 212a-212n and to each other via local area wireless links 216a-216n and cellular wireless links 126a-126n 126a′-126n′. The streaming system 600j of FIG. 6J is the same as the streaming system 600e of FIG. 6E except the functionality of the media player 102 and external partnered media control box 202 are combined.

Methods for Streaming Using Partnered Smartphone Groups

Various exemplary methods are provided herein that include a sequence of steps. The order of the steps provided is not intended to limit the invention and one skilled in the art will recognize that the order of the steps can be varied to practice the invention.

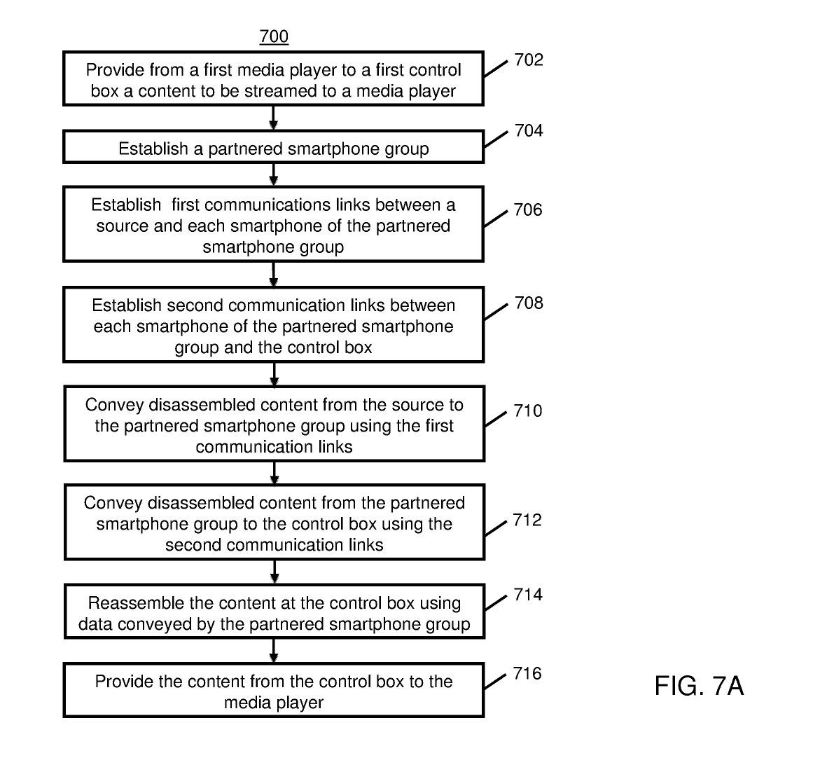

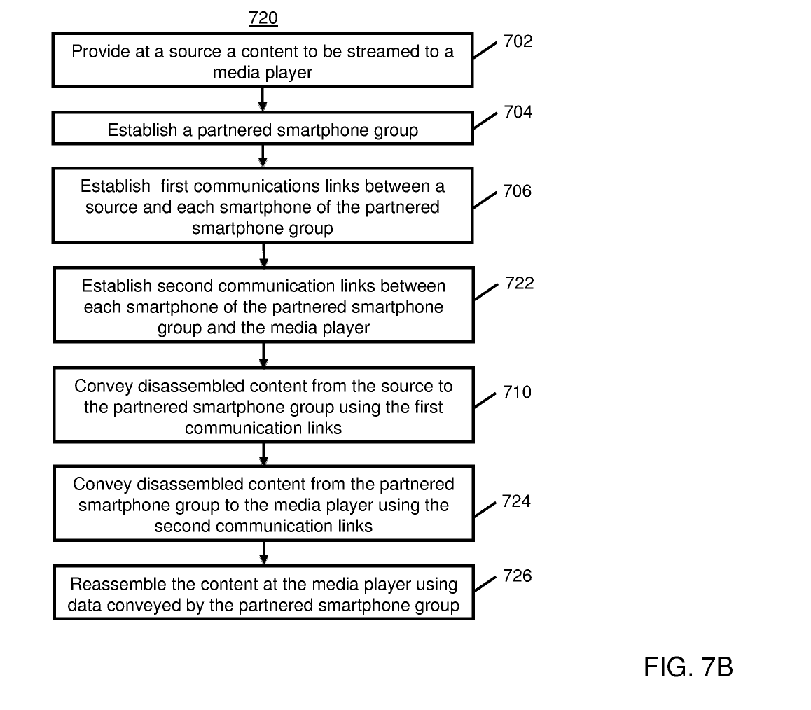

FIG. 7A depicts a first exemplary method 700 for streaming from a content source to a first media player and first control box to content source in accordance with the present invention. Referring to FIG. 7A, the method 700 includes eights steps. The first step 702 is to identify content to be streamed to the first media player from the content source. The second step 704 is to establish a partnered smartphone group. The third step 706 is to establish first communications links between the content source and each smartphone of the partnered smartphone group. The fourth step 708 is to establish second communications links between each smartphone of the partnered smartphone group and the control box. The fifth step 710 is to disassemble the identified content and convey the disassembled content to the partnered smartphone group using the first communications links. The sixth step 712 is to convey the disassembled content from the partnered smartphone group to the control box using the second communications links. The seventh step 714 is to reassemble the content at the control box using data conveyed by the partnered smartphone group and the eight step 716 is to provide the content from the control box to the media player.

FIG. 7B depicts a second exemplary method 720 for streaming between a content source and a media player in accordance with the present invention, which is the same as the first exemplary method 700 except for changes that reflect the combining of the media player and the partnered media control box. The second exemplary method 720 has seven steps instead of eight steps, where the first three steps and the same fifth step are the same as those for the first exemplary method 700, where a new fourth step 722 of the second exemplary method 720 is to establish second communications links between each smartphone of the partnered smartphone group and the media player and the last sixth through the eighth steps of the first method 700 become a sixth step 724, which is to convey the disassembled content from the partnered smartphone group to the media player using the second communications links, and a seventh step 726, which is to reassemble the content at the media player using data conveyed by the partnered smartphone group.

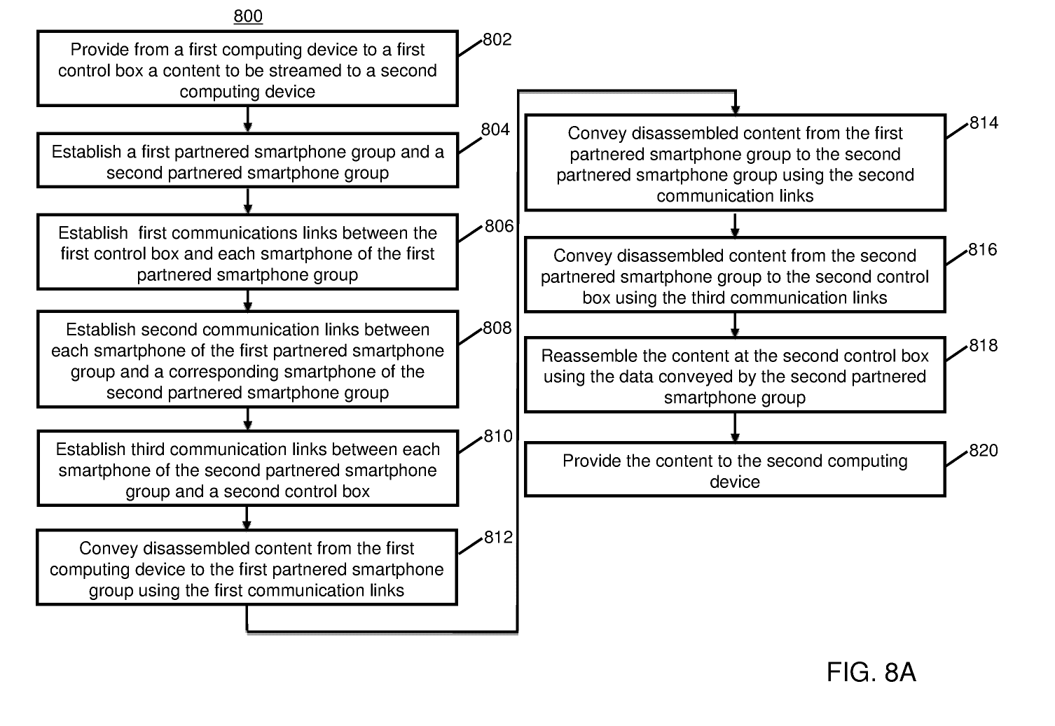

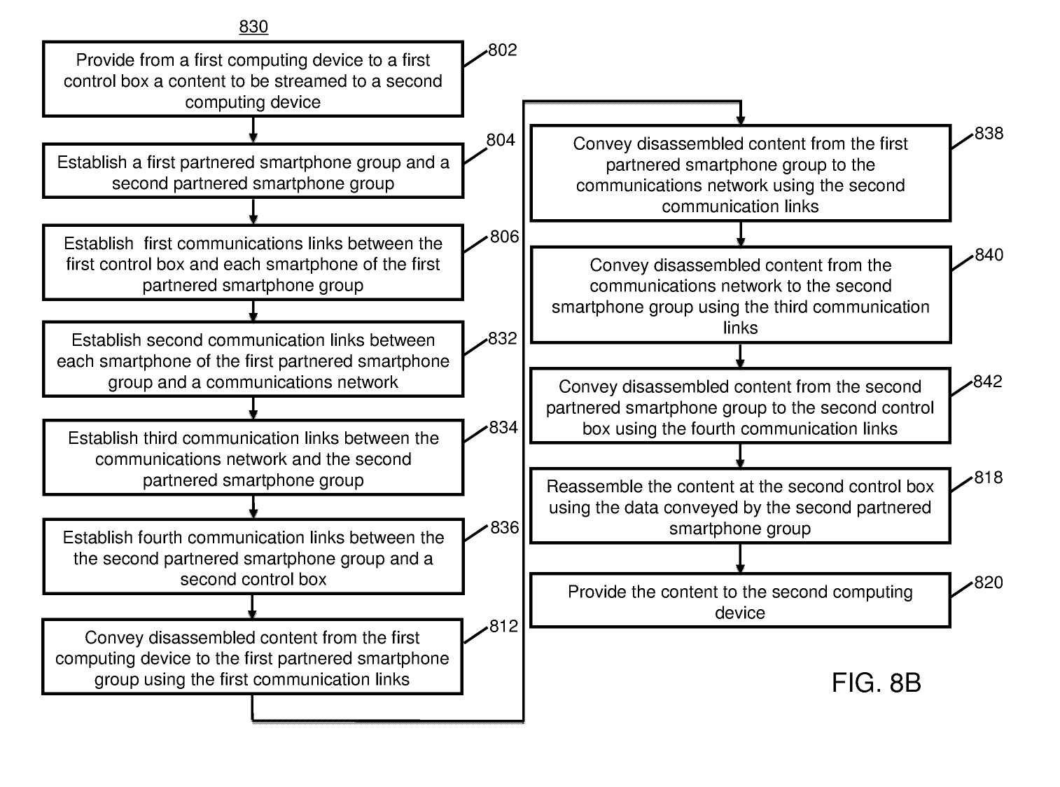

FIG. 8A depicts a first exemplary method 800 for streaming between a first computing device and first control box to a second computing device and second control box in accordance with the present invention. The method 800 includes ten steps. The first step 802 is to provide from a first computing device to a first control box a content to be streamed to a second computing device. The second step 804 is to establish a first partnered smartphone group and a second partnered smartphone group. The third step 806 is to establish first communications links between the first control box and each smartphone of the first partnered smartphone group. The fourth step 808 is to establish second communication links between each smartphone of the first partnered smartphone group and a corresponding smartphone of the second partnered smartphone group. The fifth step 810 is to establish third communication links between each smartphone of the second partnered smartphone group and a second control box. The sixth step 812 is to convey disassembled content from the first computing device to the first partnered smartphone group using the first communication links. The seventh step 814 is to convey disassembled content from the first partnered smartphone group to the second partnered smartphone group using the second communication links. The eighth step 816 is to convey disassembled content from the second partnered smartphone group to the second control box using the third communication links. The ninth step 818 is to reassemble the content at the second control box using the data conveyed by the second partnered smartphone group and the tenth step 820 is to provide the content to the second computing device.

FIG. 8B depicts a second exemplary method 830 for streaming between a first computing device and first control box to a second computing device and second control box in accordance with the present invention. The second method 830 of FIG. 8B is much like the first method 800 of FIG. 8A except for changes that reflect the smartphone groups interfacing with a communications network instead of directly. As such, the first three steps 802-806 are the same. A fourth step 832 is to establish second communications links between each smartphone of the first partnered smartphone group and a communications network. A fifth step 834 is to establish third communication links between the communications network and the second partnered smartphone group and a sixth step 836 is to establish fourth communication links between the second partnered smartphone group and a second control box. The next step 812 is the same for the two methods, which is to convey disassembled content from the first computing device to the first partnered smartphone group using the first communication links. An eighth step 838 is to convey disassembled content from the first partnered smartphone group to the communications network using the second communication links. A ninth step 840 is to convey disassembled content from the communications network to the second smartphone group using the third communication links and a tenth step 842 is to convey disassembled content from the second partnered smartphone group to the second control box using the fourth communication links. The final two steps 818 820 are the same for the two methods 800 830.

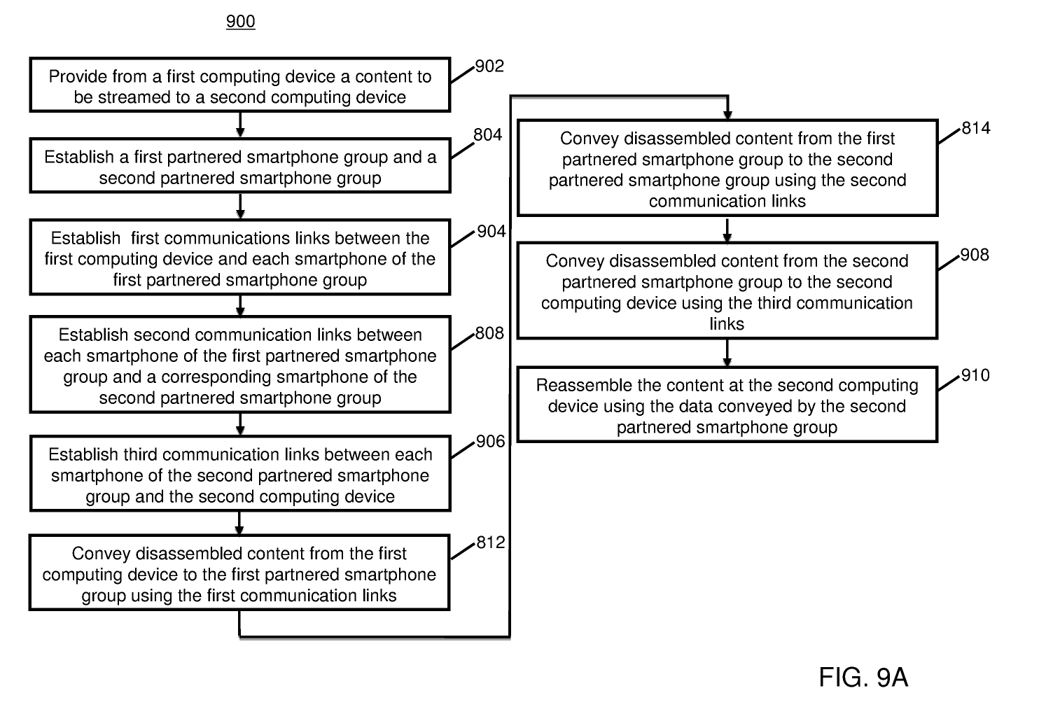

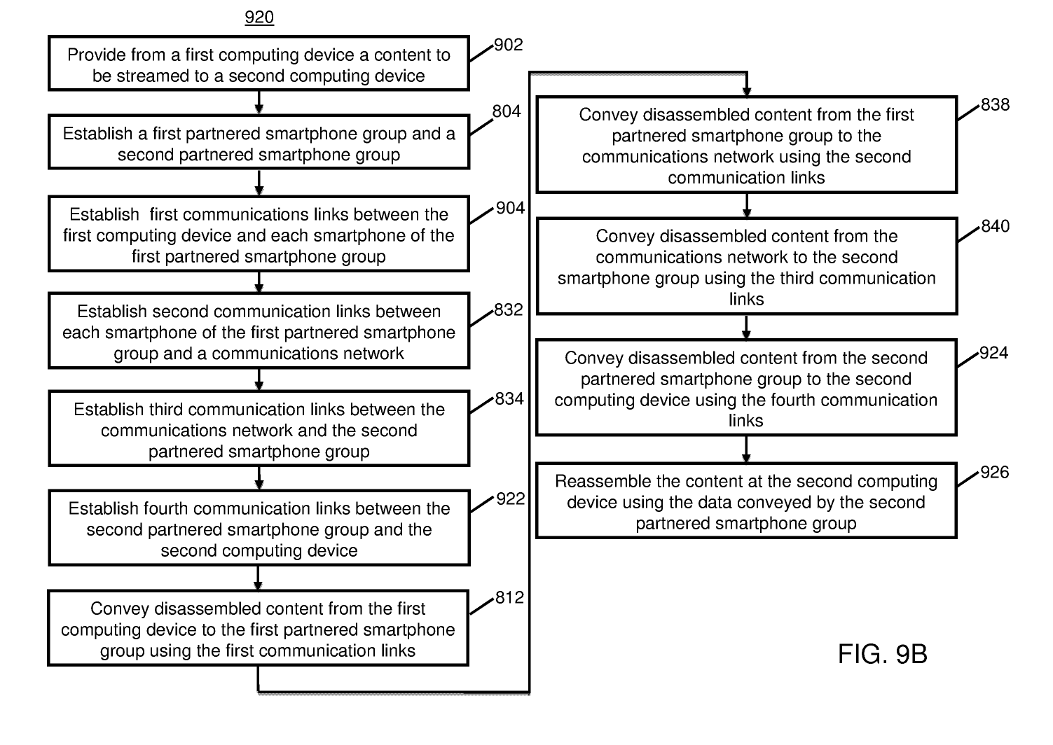

FIG. 9A depicts a first exemplary method 900 for streaming between a first computing device and a second computing device in accordance with the present invention. The method 900 of FIG. 9A is somewhat similar to the method 800 of FIG. 8A in that it involves direct communications between smartphone groups. The method 900 includes nine steps. The first step 902 is to provide from a first computing device a content to be streamed to a second computing device. The second step 804 is to establish a first partnered smartphone group and a second partnered smartphone group. The third step 806 is to establish first communications links between the first computing device and each smartphone of the first partnered smartphone group. The fourth step 808 is to establish second communication links between each smartphone of the first partnered smartphone group and a corresponding smartphone of the second partnered smartphone group. The fifth step 906 is to establish third communication links between each smartphone of the second partnered smartphone group and the second computing device. The sixth step is to convey disassembled content from the first computing device to the first partnered smartphone group using the first communication links. The seventh step 814 is to convey disassembled content from the first partnered smartphone group to the second partnered smartphone group using the second communication links. An eighth step 908 is to convey disassembled content from the second partnered smartphone group to the second computing device using the third communication links and a ninth step 910 is to reassemble the content at the second computing device using the data conveyed by the second partnered smartphone group.

FIG. 9B depicts a second exemplary method 920 for streaming between a first computing device and a second computing device in accordance with the present invention. As with the methods 800 and 830 of FIGS. 8A and 8B, the difference between the methods 900 and 920 of FIGS. 9A and 9B reflects that the smartphones communicate with each other via a communications network instead of via direct communications. Referring to FIG. 9B, the method 920 includes eleven steps. The first step 902 is to provide from a first computing device a content to be streamed to a second computing device. The second step 804 is to establish a first partnered smartphone group and a second partnered smartphone group. The third step 806 is to establish first communications links between the first computing device and each smartphone of the first partnered smartphone group. The fourth step 832 is to establish second communication links between each smartphone of the first partnered smartphone group and a communications network and the fifth step 834 is to establish third communication links between the communications network and the second partnered smartphone group. A sixth step 922 is to establish fourth communication links between the second partnered smartphone group and the second computing device. A seventh step 812 is to convey disassembled content from the first computing device to the first partnered smartphone group using the first communication links. An eighth step 838 is to convey disassembled content from the first partnered smartphone group to the communications network using the second communication links. A ninth step 840 is to convey disassembled content from the communications network to the second smartphone group using the third communication links. The tenth step 924 is to convey disassembled content from the second partnered smartphone group to the second computing device using the fourth communication links and an eleventh step 926 is to reassemble the content at the second computing device using the data conveyed by the second partnered smartphone group.

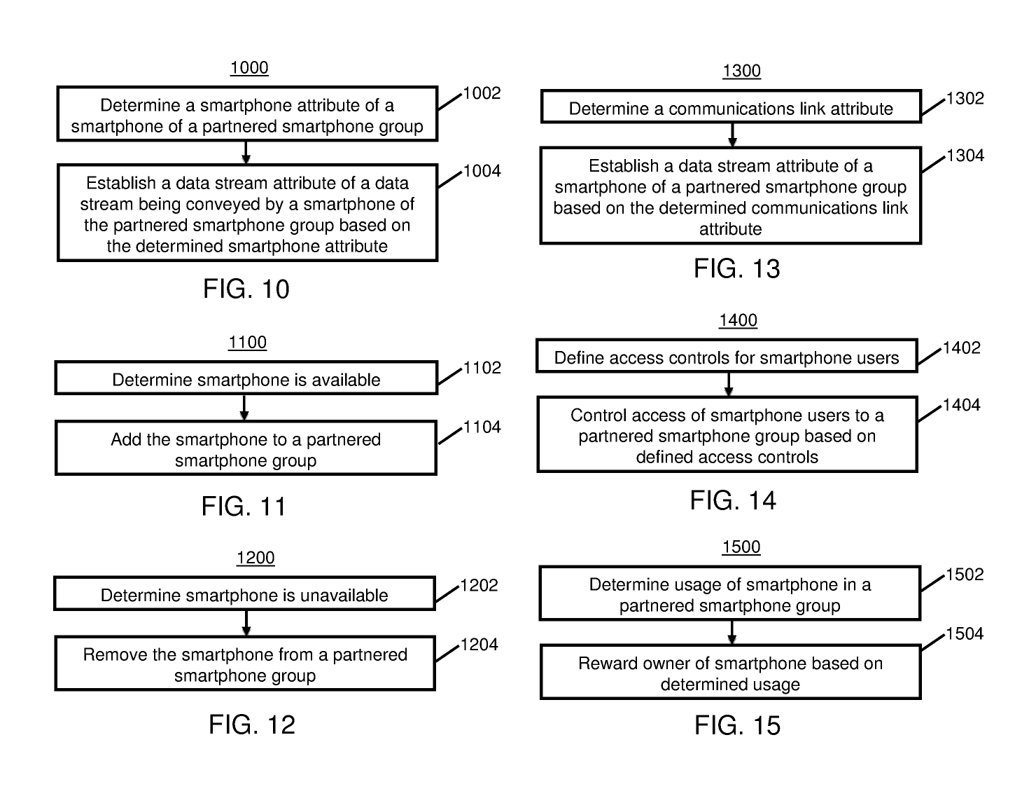

FIG. 10 depicts an exemplary method 1000 for establishing a data stream attribute based on a determined smartphone attribute. The method 1000 consists of two steps including a first step 1002 to determine a smartphone attribute of a smartphone of a partnered smartphone group and a second step 1004 to establish a data stream attribute of a data stream being conveyed by a smartphone of the partnered smartphone group based on the determined smartphone attribute. For example, weak signal strength for a given smartphone may cause smartphone management software to vary the amount of data conveyed via that smartphone or to modify data duplicated as part of a FEC technique.

FIG. 11 depicts an exemplary method 1100 for adding a smartphone to a partnered smartphone group when a smartphone is determined to be available. The method 1100 includes a first step 1102 which is to determine a smartphone is available and a second step 1104 which is to add the smartphone to a partnered smartphone group. Various approaches are possible for determining the availability of a smartphone to join a partnered smartphone group to include recognition of the establishment of a connection, a successful login as part of a login procedure, determining a smartphone is located within a predefined area based on a determined position of the smartphone, and so on. The approach could involve a manual method such as a verbal indication from a person having a smartphone to a person managing a partnered smartphone group. For example, a patron of a business could ‘check in’ at a front desk and provide a smartphone number, whereby the person at the desk could enter that smartphone number into management software to add that smartphone to a partnered smartphone group.

FIG. 12 depicts an exemplary method 1200 for removing a smartphone from a partnered smartphone group when a smartphone is determined to be unavailable. The method 1200 includes a first step 1202 which to determine a smartphone is unavailable and a second step 1204 which is to remove the smartphone from a partnered smartphone group. Various approaches are possible for determining the unavailability of a smartphone to continue participation in a partnered smartphone group to include recognition of the loss of a connection, a successful logout as part of a logout procedure, determining a smartphone is no longer located within a predefined area based on a determined position of the smartphone, and so on. The approach could involve a manual method such as a verbal indication from a person having a smartphone to a person managing a partnered smartphone group. For example, a patron of a business could ‘check out’ at a front desk and provide a smartphone number, whereby the person at the desk could enter that smartphone number into management software to remove that smartphone from a partnered smartphone group.

FIG. 13 depicts an exemplary method 1300 for establishing a data stream attribute based on a determined communications link attribute. The method 1300 includes two steps. A first step 1302 is to determine a communications link attribute and a second step 1304 is to establish a data stream attribute of a smartphone of a partnered smartphone group based on the determined communications link attribute. Generally, a monitored communications link attribute such as a signal-to-noise ratio, a packet loss rate, or the like can be used to determine that a communications link is more or less reliable and can be used to optimize data streams and their use of communications links. For example, the data conveyed by a first data stream may be increased while another data stream data rate may be decreased as a result of attributes related to the two communications links. Various well known methods for optimizing the use of communications links based on measured attributes can be applied.

FIG. 14 depicts an exemplary method 1400 for controlling access to a partnered smartphone group based on defined access controls for smartphone users. The method 1400 includes two steps. A first step 1402 is to define access controls for smartphone users and a second step 1404 is to control access of smartphone users to a partnered smartphone group based on defined access controls. As previously described, management software may enforce access to information conveyed in accordance with the system and may enforce various access control measures that determine whether a smartphone can participate in a partnered smartphone group.

FIG. 15 depicts an exemplary method 1500 for rewarding an owner of a smartphone for determined usage of the smartphone in a partnered smartphone group. The method 1500 includes two steps. A first step 1502 is to determine usage of smartphone in a partnered smartphone group and a second step 1504 is to reward the owner of the smartphone based on determined usage. Various scenarios are possible whereby smartphones of patrons of an establishment (e.g., a sports bar) are used to increase the bandwidth available to the establishment to provide digital media services to the patrons. As such digital media services increase, the patrons of the establishment benefit from the availability of the services and the owner of the establishment benefits from not having to otherwise pay for the additional bandwidth provided by the patron's smartphones. As a result, a more rewarding experience can increase business whereby the business-owner is incented to reward owners of smartphones for participating in partnered smartphone groups used to provide high bandwidth content to the establishment. As such, patrons might provide product discounts, food coupons, or the like to incentivize patrons to allow their smartphones to be used to support the business. Another scenario might involve displays at outdoor events (e.g., X-Games, a golf tournament, tennis tournament, etc.) whereby the display may have power (e.g., solar power) but are not otherwise be connected to a media source. People near the displays can join a partnered smartphone group wirelessly interfacing with the display thereby providing the display content, which might be video and sound pertaining to the outdoor event that are witnessing. As such, the people enabling the display of the content benefit are rewarded by it being available for them to enjoy. Generally, all sorts of scenarios are possible whereby people are rewarded for making their smartphone bandwidth available to others.

Under one arrangement, multiple smartphone partnering groups are arrayed to enable daisy-chaining of information via local area wireless links over distances greater than a single link would otherwise be able to traverse. With this approach, positional coordination of smartphone groups relative to their wireless communications capabilities can result in high bandwidth data streaming over moderate distances.

Under another arrangement smartphones within vehicles can work together in partnered smartphone groups to enable data streaming to media players within the vehicles. By using positional information, smartphones in nearby vehicles can work together to provide streaming content to a media player in one or more of the vehicles. As such, digital content sources (e.g., traffic or weather monitoring devices that transmit live information) could be located about an area (e.g., a city) whereby vehicles near such sources could receive information from them via their partnered smartphones. As such, duty cycling techniques could be used to provide media players in nearby vehicles high bandwidth updates in bursts, whereby the smartphones in nearby vehicles would work together to support successive high bandwidth updates to the media players in the vehicles. Generally, duty cycled high bandwidth bursts can be employed to update multiple media players whereby the smartphones in a partnered smartphone group collectively vary their wireless communications links from one media player (or partnered media control box) to the next and so on. Moreover, duty cycled high bandwidth bursts can be employed to communicate content from a content source to multiple partnered smartphone groups. One skilled in the art will recognize that various well known scheduling schemes can be used to coordinate duty cycled transmissions.

In accordance with another aspect of the invention, one or more sensors can be used as part of a streaming system, whereby a sensed condition (e.g., presence of an intruder) could cause the coordinated transmission of high bandwidth data via nearby smartphones configured as a partnered smartphone group. For example, a family might be asleep and a security system might detect an intruder and use their smartphones to transmit a high definition video stream to a security monitoring company or the police. Similarly, the smartphones of workers within an environment could collaborate to convey sensor information to a monitoring station or send any kind of high bandwidth content to a destination, for example, workers on an oil platform in the Gulf of Mexico might use their smartphones as a partnered smartphone group to stream sensor information and high definition video of a malfunctioning drilling component to the vendor of the drilling component to assist in diagnosing the problem with the component.

In accordance with yet another aspect of the invention, partnered smartphone group technology and further enabling infrastructure can be used for collaborative informational exchange across a community. For example, news could be spread across a community via daisy-chaining of partnered smartphone groups. Voting could be performed by using smartphones as voting terminals that collaborate with voting information portals and distribute results via high bandwidth data streaming via partnering of the smartphones used to collect the votes. Generally, all sorts of scenarios are possible for collaboration among content sources and persons having smartphones.

In accordance with still another aspect of the invention, the computing and/or data storage capabilities of partnered smartphones are also leveraged to support distributed computing and/or distributed data storage applications. For example, a partnered smartphone group might receive multiplexed content from a source, optionally process the multiplexed content in some manner, and/or optionally store the multiplexed content (or processed multiplexed content) for some period of time before forwarding the multiplexed content (or processed multiplexed content) to a destination. Various strategies are also possible for using a smartphone partnered group as a long term storage mechanism, particularly if the multiplexed content were encrypted, whereby at some later time, the information would be retrieved by the source or forwarded to an end destination. For certain security applications, such an approach would provide data security since no one smartphone could be used to access the stored information.

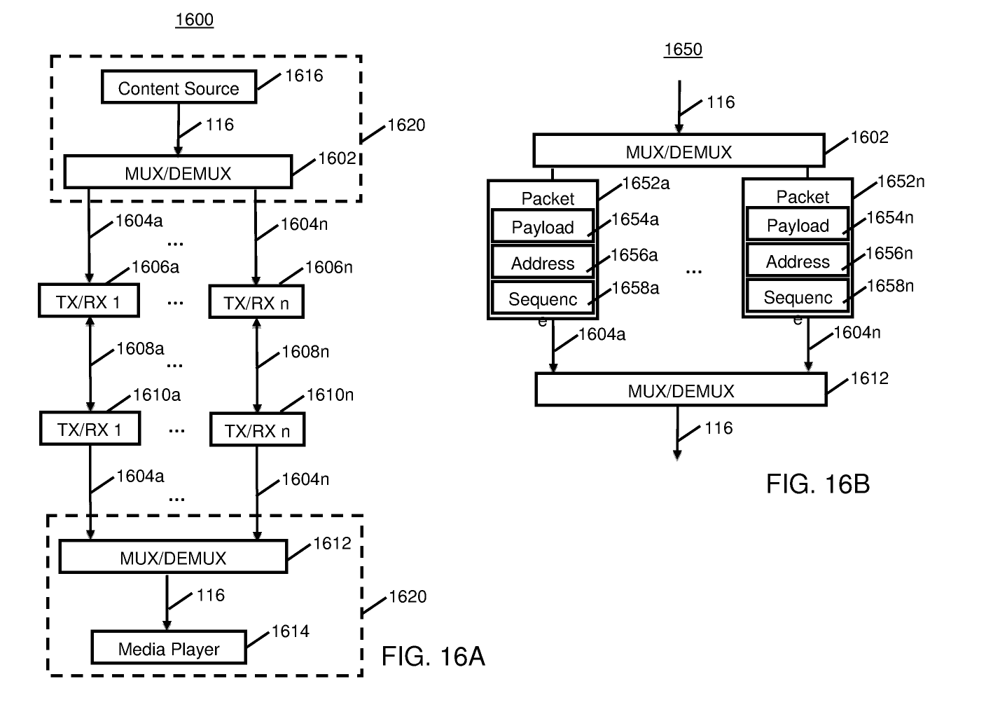

FIG. 16A depicts an exemplary method 1600 of multiplexing content from a content source into multiple content portions for conveyance as multiple data streams by at least one partnered smartphone group. In the method 1600, content 116 is multiplexed (i.e., disassembled) into multiple content portions for conveyance as multiple data streams 1604a-1604n by multiplexer/demultiplexer (MUX/DEMUX) device 1602. From MUX/DEMUX device 1602, the multiple data streams 1604-1604n are sent to transmitters/receivers 1606a-1606n for transmission along multiple communication links 1608a-1608n to receivers/transmitters 1610a-1610n. From receiver 1610, the multiple data streams 1604a-1604n are demultiplexed back into content 116 by demultiplexer/multiplexer (DEMUX/MUX) device 1612 for display on media player 1614. The flow of content 116 may also be reversed using the same, or similar, components of FIG. 16A to enable two way communications. Additionally, content source 1616 and MUX/DEMUX device 1602 may be combined into device 1618 while media player 1614 and DEMUX/MUX device 1612 may be combined into device 1620.

FIG. 16B depicts an exemplary method 1650 of formatting the multiple data streams depicted in, for example, FIG. 16A. In method 1650, after receiving the content 116, the DEMUX/MUX 1602 may multiplex (i.e., disassemble) the content into multiple content portions, such as data packets 1652a-1652n, for conveyance as multiple data streams 1604a-1604n. Each data stream 1604a-1604n may be comprised of at least one data packet 1652a-1652n. Each data packet 1652a-1652n may contain a payload 1654a-1654n containing a portion of the content 116, an address 1656a-1656n identifying a final destination(s), such as receiver 1610, and sequence information 1658a-1658n identifying the order in which each data packets 1652a-1652n are to be recombined by, for example, DEMUX/MUX 1612 into content 116.

While particular embodiments of the invention have been described, it will be understood, however, that the invention is not limited thereto, since modifications may be made by those skilled in the art, particularly in light of the foregoing teachings.

1. A method for delivering a content stream from a content source to a content player, comprising:
associating a plurality of smartphones with a partnered smartphone group that share their resources for delivering the content stream transmitted from the content source based on a partnership profile stored in a partnership profile storage device;
executing a content segmentation process at a segmentation processing node that converts the content stream into a plurality of content segments according to a segmentation rule;
transmitting the plurality of content segments to the partnered smart phone group over a first plurality of communication links; and
transmitting the plurality of content segments form the smartphone group towards the content player over a second plurality of communication links, wherein the transmission over the second plurality of communication links is based on information stored in the partnership profile that specify at least one condition information for at least one of the plurality of smartphones to share its resource with resources of one or more other smartphones of the plurality of smartphones.

2. The method of claim 1 further comprises executing a recombining process at a recombining processing node that recombines the plurality of content segments to generated a recombined content stream; and
applying the recombined content stream to the content player.

3. The method of claim 2, wherein the segmentation process comprises a multiplexing process and the recombining process comprises a demultiplexing process.

4. The method of claim 1, wherein the resources comprise at least one of communication resources, computing resources and storage resources.

5. The method of claim 1, wherein the condition information relates to position information associated with the plurality of smartphones relative to each other.

6. The method of claim 1, wherein the condition information relates to at least one of a smartphone attribute and a communication link attribute.

7. The method of claim 6, wherein communication link attribute relates to a received signal strength at one of the smartphones.

8. The method of claim 1, wherein the first plurality of communication links comprises wireless links and the second plurality of communication links comprises wired communication links.

9. The method of claim 1, wherein the first plurality of communication links comprises wired links and the second plurality of communication links comprises wired communication links.

10. The method of claim 1, wherein the first plurality of communication links comprises wired links and the second plurality of communication links comprises wireless communication links.

11. The method of claim 1, wherein the first plurality of communication links comprises communication links of a cellular network.

12. The method of claim 1, wherein the partnership profile storage device comprises a database accessible by a server associated with the content source.

13. The method of claim 1, wherein the partnership profile storage device comprises a storage device located in a smartphone.

14. The method of claim 1, wherein the plurality of smartphones communicate with each other over an ad-hoc network.

15. The method of claim 1, wherein the segmentation processing node is located at the content source.

16. The method of claim 15, wherein the content source comprises a stand-alone computer.

17. The method of claim 1, wherein the segmentation processing node is located at a content provider.

18. The method of claim 1, wherein the recombining processing node is located at the content player.

19. The method of claim 1, further comprising removing a smartphone from the partnered smartphone group when the smartphone is determined to be unavailable.

20. The method of claim 1, further comprising adding a smartphone to the partnered smartphone group when the smartphone is determined to be available.

21. The method of claim 1, wherein the content stream is at least one of deadline driven content stream and non-deadline driven content stream.
